(19) United States
(12) Patent Application Publication
(10) Pub. No.: US 2026/0268851 A1
(43) Pub. Date: Sep. 10, 2026

(54) DRIVING METHOD FOR A PIXEL CIRCUIT AND A DISPLAY PANEL

(71) Applicants: Kunshan Govisionox Optoelectronics Co., Ltd., Kunshan (CN); Yungu (Gu’an) Technology Co., Ltd., Langfang (CN)

(72) Inventors: Junfeng LI, Kunshan (CN); Genmao HUANG, Kunshan (CN); Guangyuan SUN, Kunshan (CN); Cuili GAI, Kunshan (CN); Zhili MA, Kunshan (CN); Bo JIANG, Kunshan (CN)

(73) Assignees: Kunshan Govisionox Optoelectronics Co., Ltd., Kunshan (CN); Yungu (Gu’an) Technology Co., Ltd., Langfang (CN)

(21) Appl. No.: 19/660,257

(22) Filed: Apr. 28, 2026

Related U.S. Application Data
(63) Continuation of application No. PCT/CN2024/128811, filed on Oct. 31, 2024.

(30) Foreign Application Priority Data
Oct. 31, 2023 (CN) 202311434931.8
Jun. 19, 2024 (CN) 202410796535.8

(51) Int. Cl. G09G 3/3233

(52) U.S. Cl. CPC G09G 3/3233; G09G 2300/0842; G09G 2300/0861; G09G 2310/08; G09G 2320/0233; G09G 2320/0242; G09G 2320/0257; G09G 2330/12

(57) ABSTRACT

A driving method for driving a pixel circuit and a display panel. The pixel circuit includes a data writing module, a driving module and a first reset module; the data writing module is connected to the driving module , and the first reset module is connected to a control terminal of the driving module; within one display frame, the driving method for the pixel circuit includes: in a first reset phase, controlling the first reset module to reset the control terminal of the driving module at least once; in a second reset phase, controlling the first reset module to reset the control terminal of the driving module at least once; and in a first data writing phase, controlling the data writing module to write a first data voltage to the control terminal of the driving module at least once.

### CROSS REFERENCE TO RELATED APPLICATION

This application is a continuation application of International Application No. PCT/CN2024/128811 filed on October 31, 2024, which claims priority to Chinese Patent Application No. 202311434931.8 filed with the China National Intellectual Property Administration on October 31, 2023, and to Chinese Patent Application No. 202410796535.8 filed with the China National Intellectual Property Administration on June 19, 2024, the entire contents of which are incorporated herein by reference.

### FIELD

The present application relates to the field of display technology, in an embodiment, to a driving method for a pixel circuit and a display panel.

### BACKGROUND

Organic Light Emitting Display (OLED) flat display devices have been widely applied to various electronic products such as mobile phones, televisions, notebook computers, and desktop computers due to their advantages of high image quality, power saving, thin body and wide application range.

However, the display effect of current display products needs to be improved, that is, display products have a problem of a poor display effect.

### SUMMARY

The present application provides a driving method for a pixel circuit and a display panel to solve the problem of a poor display effect of display products.

According to one aspect of the present application, a driving method for a pixel circuit is provided, and the pixel circuit includes a data writing module, a driving module and a first reset module; the data writing module is connected to the driving module, and the first reset module is connected to a control terminal of the driving module; within one display frame, the method includes:

in a first reset phase, controlling the first reset module to reset the control terminal of the driving module at least once;

in a second reset phase, controlling the first reset module to reset the control terminal of the driving module at least once;

in a first data writing phase, controlling the data writing module to write a first data voltage to the control terminal of the driving module at least once.

According to another aspect of the present application, a driving method for a pixel circuit is provided, and the pixel circuit includes a data writing module, a driving module and a first reset module; the data writing module is connected to the driving module, and the first reset module is connected to a control terminal of the driving module; within one display frame, the method includes:

in a first reset phase, controlling the first reset module to reset the control terminal of the driving module at least once;

in a second data writing phase, controlling the data writing module to write a second data voltage to the control terminal of the driving module at least once;

in a first data writing phase, controlling the data writing module to write a first data voltage to the control terminal of the driving module at least once.

According to another aspect of the present application, a driving method for a pixel circuit is provided, and the pixel circuit includes a data writing module, a driving module, a first reset module and a storage module; the data writing module is connected to the driving module, and the first reset module is connected to a control terminal of the driving module; a first terminal of the storage module is connected to a DC signal, and a second terminal of the storage module is connected to the control terminal of the driving module; within one display frame, the method includes:

in a first reset phase, controlling the first reset module to reset the control terminal of the driving module at least once;

in a reset maintaining phase, controlling the first reset module and the data writing module to turn off, to cause the storage module to maintain a potential of the control terminal of the driving module; or, in a part of a period of the reset maintaining phase, controlling the first reset module to reset the control terminal of the driving module at least once, and in another part of a period of the reset maintaining phase, controlling the first reset module and the data writing module to turn off;

in a first data writing phase, controlling the data writing module to write a first data voltage to the control terminal of the driving module at least once;

herein the another part of the period of the reset maintaining phase is a period from an end of a last reset of the control terminal of the driving module by the first reset module in the reset maintaining phase to a start of the first data writing phase.

According to another aspect of the present application, a display panel is provided, and the display panel includes a plurality of first gate driving circuits, a plurality of second gate driving circuits and a plurality of pixel circuits; the pixel circuit includes a data writing module, a driving module and a first reset module; the data writing module is connected to the driving module, and the first reset module is connected to a control terminal of the driving module;

one of the first gate driving circuits is connected to first reset modules of k rows of the pixel circuits, and the first gate driving circuit is configured to transmit a first gate driving signal to the first reset modules of corresponding k rows of pixel circuits;

one of the second gate driving circuits is connected to data writing modules of one row of the pixel circuits, and the second gate driving circuit is configured to transmit a second gate driving signal to the data writing modules of a corresponding one row of pixel circuits;

a single effective pulse width of the first gate driving signal is n times a single effective pulse width of the second gate driving signal.

### BRIEF DESCRIPTION OF THE DRAWINGS

FIG. 1 is a structural schematic diagram of a pixel circuit provided by an embodiment of the present application;

FIG. 2 is a flowchart of a driving method for a pixel circuit provided by an embodiment of the present application;

FIG. 3 is a driving timing diagram of a pixel circuit provided by an embodiment of the present application;

FIG. 4 is a flowchart of another driving method for a pixel circuit provided by an embodiment of the present application;

FIG. 5 is another driving timing diagram of a pixel circuit provided by an embodiment of the present application;

FIG. 6 is yet another driving timing diagram of a pixel circuit provided by an embodiment of the present application;

FIG. 7 is a structural schematic diagram of yet another pixel circuit provided by an embodiment of the present application;

FIG. 8 is a flowchart of yet another driving method for a pixel circuit provided by an embodiment of the present application;

FIG. 9 is yet another driving timing diagram of a pixel circuit provided by an embodiment of the present application;

FIG. 10 is a flowchart of yet another driving method for a pixel circuit provided by an embodiment of the present application;

FIG. 11 is yet another driving timing diagram of a pixel circuit provided by an embodiment of the present application;

FIG. 12 is yet another driving timing diagram of a pixel circuit provided by an embodiment of the present application;

FIG. 13 is yet another driving timing diagram of a pixel circuit provided by an embodiment of the present application;

FIG. 14 is yet another driving timing diagram of a pixel circuit provided by an embodiment of the present application;

FIG. 15 is a flowchart of yet another driving method for a pixel circuit provided by an embodiment of the present application;

FIG. 16 is yet another driving timing diagram of a pixel circuit provided by an embodiment of the present application;

FIG. 17 is a flowchart of yet another driving method for a pixel circuit provided by an embodiment of the present application;

FIG. 18 is yet another driving timing diagram of a pixel circuit provided by an embodiment of the present application;

FIG. 19 is a flowchart of yet another driving method for a pixel circuit provided by an embodiment of the present application;

FIG. 20 is yet another driving timing diagram of a pixel circuit provided by an embodiment of the present application;

FIG. 21 is a flowchart of yet another driving method for a pixel circuit provided by an embodiment of the present application;

FIG. 22 is yet another driving timing diagram of a pixel circuit provided by an embodiment of the present application;

FIG. 23 is a flowchart of yet another driving method for a pixel circuit provided by an embodiment of the present application;

FIG. 24 is yet another driving timing diagram of a pixel circuit provided by an embodiment of the present application;

FIG. 25 is yet another driving timing diagram of a pixel circuit provided by an embodiment of the present application;

FIG. 26 is a structural schematic diagram of a display panel provided by an embodiment of the present application;

FIG. 27 is a structural schematic diagram of another display panel provided by an embodiment of the present application;

FIG. 28 is a structural schematic diagram of yet another pixel circuit provided by an embodiment of the present application.

### DETAILED DESCRIPTION

The terms "first", "second" and the like in the specification and claims of the present application and the above drawings are used to distinguish similar objects, and are not necessarily used to describe a specific order or sequence. It should be understood that the data so used may be interchanged under appropriate circumstances and the embodiments of the present application described herein can be implemented in orders other than those illustrated or otherwise described herein. Furthermore, the terms "comprising" and "having" and any variations thereof are intended to cover non-exclusive inclusions, in an embodiment, a process, method, system, product or device that includes a series of steps or units shown in the embodiments of the present application may also include other processes, methods, systems, products and devices that may not be listed for the series of steps or units, or other steps or units inherent to these processes, methods, systems, products or devices.

An organic light-emitting diode display panel emits light through current driving, and the display panel includes a plurality of pixel circuits and organic light-emitting diodes, and the plurality of pixel circuits may be arranged in an array. The pixel circuits include driving transistors, and the driving transistors are connected to the organic light-emitting diodes. The driving transistors in the pixel circuits may generate driving currents according to data voltages, and the organic light-emitting diodes emit light in response to the driving currents. However, when displaying an image, the driving transistors are turned on, and the driving transistors are subjected to a positive voltage stress. When the driving transistors are subjected to the positive voltage stress for a long time, characteristics of the driving transistors will shift, and when switching to a next display gray level, a brightness deviation will occur. When displaying an image, the organic light-emitting diodes at different positions have different target brightnesses, so different driving transistors receive different target data voltages, causing different driving transistors to be subjected to different positive voltage stresses, and different driving transistors have different characteristic changes. Therefore, different driving transistors generate different driving currents under the same gray level, thereby causing different organic light-emitting diodes to have different display brightnesses. Therefore, when switching from display images of different gray levels to a display image of the same gray level, each driving transistor corresponds to a different brightness deviation of the organic light-emitting diode, resulting in an afterimage, making the display uniformity of the display panel poor and affecting the display effect of the display panel.

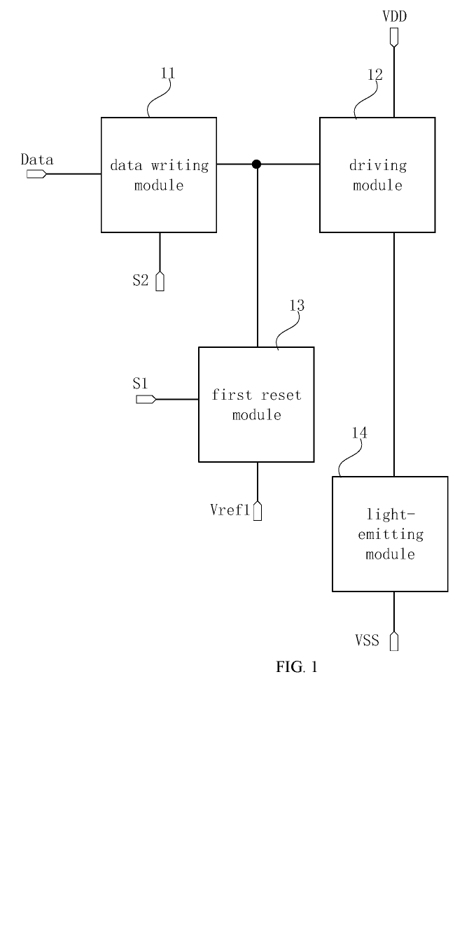

In view of the above problems, embodiments of the present application provide a driving method for a pixel circuit. FIG. 1 is a structural schematic diagram of a pixel circuit provided by an embodiment of the present application. Referring to FIG. 1, the pixel circuit includes a data writing module 11, a driving module 12 and a first reset module 13; the data writing module 11 is connected to the driving module 12, and the first reset module 13 is connected to a control terminal of the driving module 12.

The data writing module 11 may be connected to the control terminal of the driving module 12, the data writing module 11 is connected to a data line Data, and transmits a data voltage on the data line Data to the control terminal of the driving module 12. The data writing module 11 may also be connected to a first terminal of the driving module 12, and writes the data voltage from the first terminal of the driving module 12 to the control terminal of the driving module 12. FIG. 1 shows a case where the data writing module 11 is connected to the control terminal of the driving module 12.

The first reset module 13 is connected to the control terminal of the driving module 12, the first reset module 13 is connected to a first reset voltage Vref1, and the first reset module 13 can transmit the first reset voltage Vref1 to the control terminal of the driving module 12, and reset the control terminal of the driving module 12. The first terminal of the driving module 12 may be connected to a first power source VDD. The pixel circuit may further include a light-emitting module 14, a second terminal of the driving module 12 may be connected to a first terminal of the light-emitting module 14, and a second terminal of the light-emitting module 14 is connected to a second power source VSS. A voltage of the first power source VDD may be a positive voltage, and a voltage of the second power source VSS is zero or a negative voltage. In this way, a current loop may be formed among the first power source VDD, the driving module 12, the light-emitting module 14 and the second power source VSS, the driving module 12 may generate a driving current according to a data voltage, and the light-emitting module 14 may emit light in response to the driving current.

The pixel circuit may be connected to a gate driving circuit, the gate driving circuit provides a gate driving signal to the pixel circuit, the gate driving signal may control whether the first reset module 13 is turned on, and may also control whether the data writing module 11 is turned on, and the gate driving signals written to the first reset module 13 and the data writing module 11 are different. In an embodiment, a control terminal of the first reset module 13 is connected to a first gate driving line S1, and the first gate driving line S1 provides a first gate driving signal to the first reset module 13. A control terminal of the data writing module 11 is connected to a second gate driving line S2, and the second gate driving line S2 may provide a second gate driving signal to the data writing module 11.

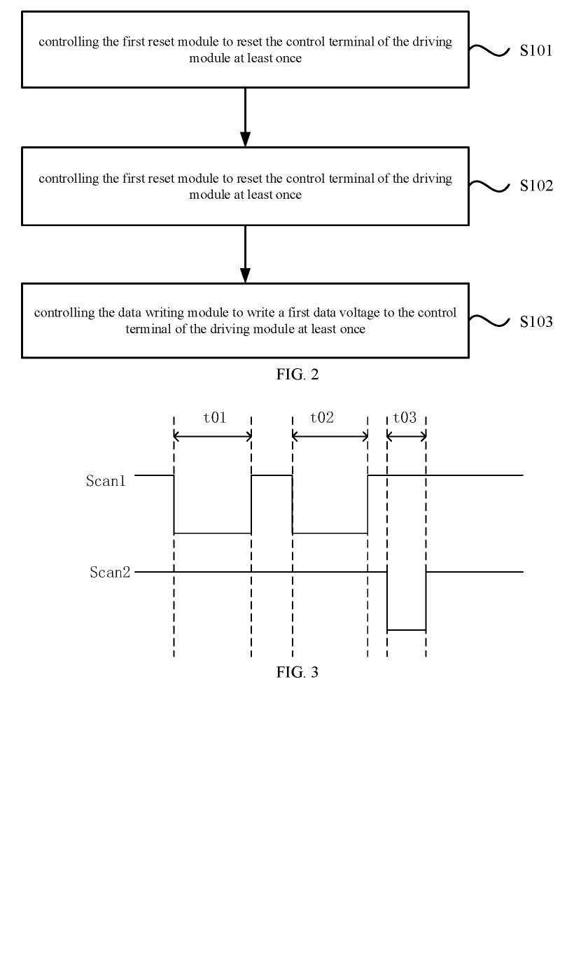

FIG. 2 is a flowchart of a driving method for a pixel circuit provided by an embodiment of the present application. Referring to FIG. 2, within one display frame, the driving method for the pixel circuit includes:

S101, in a first reset phase, controlling the first reset module to reset the control terminal of the driving module at least once.

In an embodiment, FIG. 3 is a driving timing diagram of a pixel circuit provided by an embodiment of the present application. As shown in FIG. 1 and FIG. 3, in a first reset phase t01, the first gate driving signal Scan1 transmitted by the first gate driving line S1 is at an effective level, controlling the first reset module 13 to be turned on at least once, and the first reset module 13 transmits the first reset voltage Vref1 to the control terminal of the driving module 12 at least once, to reset the control terminal of the driving module 12 at least once. In this way, a residual charge from a previous frame can be cleared, and a reverse voltage stress (opposite to a voltage stress when the driving module 12 is turned on) can be applied to the driving module 12, thereby reducing a degree of a characteristic shift caused by a long-time conduction of the driving module 12, improving characteristics of the driving module 12, and avoiding an afterimage problem caused by a characteristic change when the driving module 12 is turned on in the previous frame, which is beneficial to improving the display effect of the display panel where the pixel circuit is located.

In the first reset phase, the first reset module 13 may reset the control terminal of the driving module 12 multiple times, thereby applying the reverse voltage stress to the driving module 12 multiple times, to better improve the characteristics of the driving module 12. Even the driving module 12 with a large characteristic shift can well recover characteristics, and each driving module 12 can better recover characteristics before generating a driving current. An upper limit of the number of times that the first reset module 13 is turned on in the first reset phase may be determined according to an actual situation, in an embodiment, determined according to a proportion of a non-light-emitting phase in one driving cycle.

When the first reset module 13 resets the control terminal of the driving module 12 in the first reset phase, the first reset module 13 may perform a reset continuously multiple times, or may perform a reset intermittently multiple times.

S102, in a second reset phase, controlling the first reset module to reset the control terminal of the driving module at least once.

In an embodiment, as shown in FIG. 1 and FIG. 3, in a second reset phase t02, the first gate driving signal Scan1 transmitted by the first gate driving line S1 is at an effective level, controlling the first reset module 13 to be turned on at least once, and the first reset module 13 transmits the first reset voltage Vref1 to the control terminal of the driving module 12 at least once, to reset the control terminal of the driving module 12 at least once. In this way, the control terminal of the driving module 12 can be continuously reset, increasing the number of times and a duration of applying the reverse voltage stress to the driving module 12, thereby improving the characteristics of the driving module 12, providing time for the driving module 12 to recover characteristics, and ensuring that when the driving module 12 generates a driving current, the characteristics recover well. Therefore, even the driving module 12 with a large characteristic shift can well recover characteristics, ensuring that characteristics of each driving module 12 are well recovered, and under the same gray level, driving currents generated by the driving modules 12 tend to be consistent, and light-emitting brightnesses of different light-emitting modules 14 tend to be consistent, which can improve a display uniformity of the display panel and improve the display effect of the display panel. Moreover, after switching an image, if characteristics of the driving module 12 have not recovered, different driving currents will be generated by different driving modules 12 during a first frame display, and large differences in a light-emitting efficiency of light-emitting modules 14 of different light-emitting colors will occur, causing a sliding color shift problem, that is, a trailing phenomenon can be avoided.

When the first reset module 13 resets the control terminal of the driving module 12 in the second reset phase, the first reset module 13 may perform a reset continuously multiple times, or may perform a reset intermittently multiple times.

S103, in a first data writing phase, controlling the data writing module to write a first data voltage to the control terminal of the driving module at least once.

In an embodiment, as shown in FIG. 1, in a first data writing phase t03, the second gate driving signal Scan2 on the second gate driving line S2 is at an effective level, controlling the data writing module 11 to be turned on, and the data writing module 11 transmits the first data voltage on the data line Data to the control terminal of the driving module 12, facilitating the driving module 12 to generate a driving current according to the first data voltage, and the light-emitting module 14 to emit light in response to the driving current. In one embodiment, the first data voltage is a data voltage corresponding to the pixel circuit of the current row.

In a related technology, the second gate driving signal corresponding to the data writing module 11 is a shift of the first gate driving signal corresponding to the first reset module 13, that is, the second gate driving signal is a next-level signal of the first gate driving signal. However, in one embodiment of the present embodiment, the first gate driving signal is unrelated to the second gate driving signal, and the number of times and the duration of the effective level of the first gate driving signal can be adjusted according to an actual requirement (such as a degree of an afterimage), and the first gate driving signal can be adjusted for different working states (such as the display panel displaying different images), thereby better recovering the characteristics of the driving module 12.

The above effective level may be a high level or a low level, that is, the data writing module 11 and the first reset module 13 may be turned on in response to a high level, or may be turned on in response to a low level. FIG. 3 illustrates a case where the effective level is a low level.

In one embodiment of the present embodiment, by controlling the first reset module to reset the control terminal of the driving module at least once in the first reset phase, and controlling the first reset module to reset the control terminal of the driving module at least once in the second reset phase, at least two resets of the control terminal of the driving module are achieved, which can increase the duration and the number of times of applying the reverse voltage stress to the driving module. Even the driving module with a large characteristic shift can well recover characteristics, and each driving module can better recover characteristics, and driving currents generated by different driving modules under the same gray level tend to be consistent, making light-emitting brightnesses of different light-emitting modules tend to be consistent, which can improve the display uniformity of the display panel, avoid an afterimage, and improve the display effect of the display panel.

Based on the above embodiments, the phases that the driving method may also include are described below.

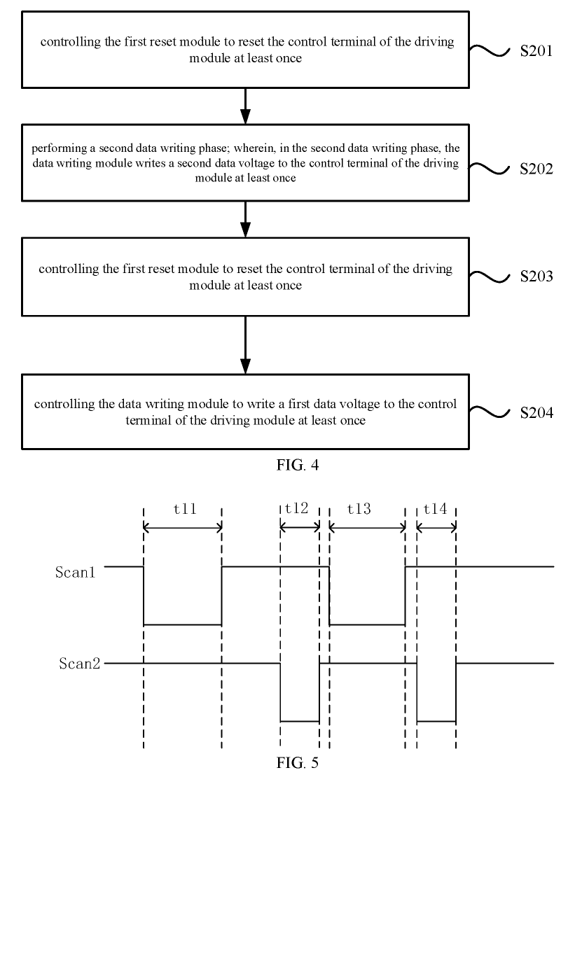

FIG. 4 is a flowchart of another driving method for a pixel circuit provided by an embodiment of the present application. In an embodiment, referring to FIG. 4, within one display frame, the driving method for the pixel circuit includes:

S201, in a first reset phase, controlling the first reset module to reset the control terminal of the driving module at least once.

In an embodiment, FIG. 5 is another driving timing diagram of a pixel circuit provided by an embodiment of the present application. As shown in FIG. 5, in the first reset phase t11, the first gate driving signal Scan1 on the first gate driving line S1 is at an effective level, controlling the first reset module 13 to reset the control terminal of the driving module 12.

S202, performing a second data writing phase; and, in the second data writing phase, the data writing module writes a second data voltage to the control terminal of the driving module at least once.

The second data voltage is a first data voltage corresponding to pixel circuits of several preceding rows of the current row. In an embodiment, when the current row is an a-th row, the several preceding rows are (a-b)-th rows, and b may be a positive integer greater than or equal to 1. Because when the current row performs the second data writing phase, the several preceding rows have already performed or are performing the first data writing phase, the second data writing phase can write the first data voltages of the several preceding rows for a data pre-charge. When an image to be displayed is a solid color image, the first data voltage is equal to the second data voltage, that is, the data voltage corresponding to the several preceding rows is the same as the data voltage corresponding to the current row. When an image to be displayed is a non-solid color image, the first data voltage is different from the second data voltage.

In an embodiment, as shown in FIG. 1 and FIG. 5, in a second data writing phase t12, the second gate driving signal Scan2 on the second gate driving line S2 is at an effective level at least once, controlling the data writing module 11 to be turned on at least once, and the data writing module 11 transmits the second data voltage to the control terminal of the driving module 12 at least once. A voltage of a first terminal of the driving module 12 is a first power voltage, the first power voltage may be a positive voltage, and the second data voltage may be a negative voltage, so a current stress can be applied to the driving module 12, and all driving modules 12 are unified in advance in a state under an input of the first data voltage, avoiding large differences in driving currents generated by the driving modules 12 under the same gray level, which can improve a display uniformity. By applying the current stress to the driving module 12 to improve the characteristics of the driving module 12, it is also possible to avoid a large difference between the driving current generated by the driving module 12 and the driving current corresponding to a target brightness in a first frame image after switching an image, avoiding a large difference between a first frame brightness and the target brightness after switching the image, which can improve the display effect of the display panel.

In an embodiment, FIG. 5 shows a case where the data writing module 11 is turned on once in the second data writing phase t12.

S203, in a second reset phase, controlling the first reset module to reset the control terminal of the driving module at least once.

In an embodiment, as shown in FIG. 5, in the second reset phase t13, the first gate driving signal Scan1 on the first gate driving line S1 is at an effective level, controlling the first reset module 13 to reset the control terminal of the driving module 12.

S204, in a first data writing phase, controlling the data writing module to write a first data voltage to the control terminal of the driving module at least once.

In an embodiment, as shown in FIG. 5, in the first data writing phase t14, the second gate driving signal Scan2 on the second gate driving line S2 is at an effective level, controlling the data writing module 11 to be turned on, and the data writing module 11 transmits the first data voltage on the data line Data to the control terminal of the driving module 12.

By performing the second reset phase and the first data writing phase, after a data pre-charge (the second data writing phase), a charge can be cleared, and when the first data voltage is written in the first data writing phase, that is, when the first data voltage is written when characteristics of the driving module 12 are recovered, it can be ensured that the driving module 12 better generates a driving current according to the written first data voltage.

In some embodiments, in an embodiment, in the second data writing phase, the data writing module 11 writes the second data voltage to the control terminal of the driving module 12 at least twice.

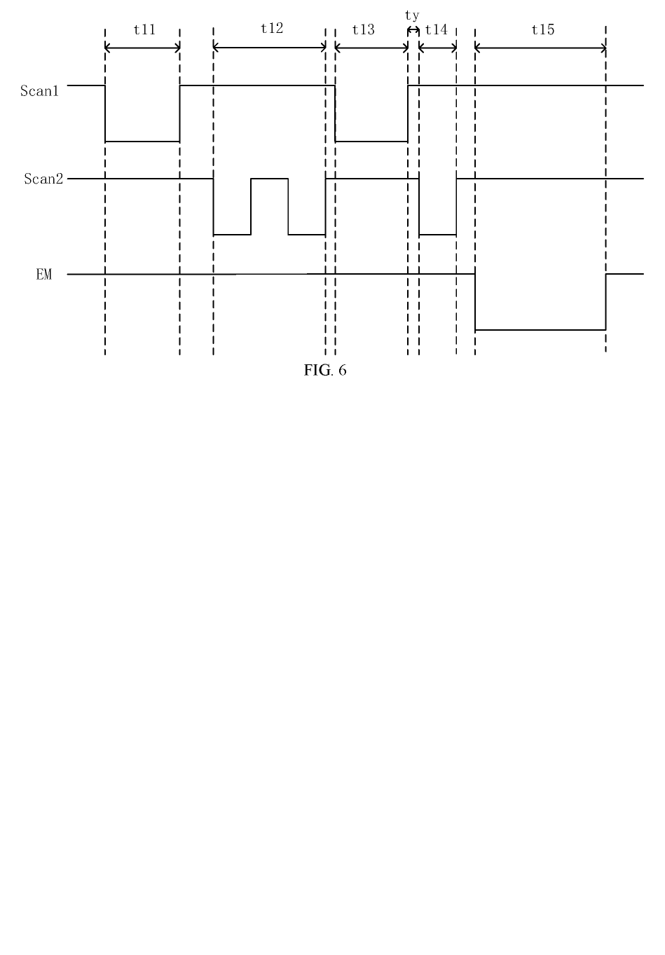

FIG. 6 is another driving timing diagram of a pixel circuit provided by an embodiment of the present application. As shown in FIG. 6, in the second data writing phase t12, the second gate driving signal Scan2 on the second gate driving line S2 has two effective levels, controlling the data writing module 11 to be turned on twice, and the data writing module 11 transmits the second data voltage to the control terminal of the driving module 12 twice. In this way, the duration and the number of times of applying the current stress to the driving module 12 can be increased, the characteristics of the driving module 12 can be better improved, the difference between the driving current generated by the driving module 12 and the driving current corresponding to a target brightness can be reduced, avoiding a large difference between a first frame brightness and the target brightness after switching an image, which can improve the display effect of the display panel.

In some other embodiments, in the second data writing phase t12, the data writing module 11 can also be controlled to be turned on multiple times, increasing the duration and the number of times of applying the current stress to the driving module 12, which can better improve the characteristics of the driving module 12. The present embodiment does not limit the number of effective levels in the second data writing phase t12.

In one embodiment of the present embodiment, by setting the first data writing phase and the second data writing phase, not only can a current stress be applied to the driving module, but also the states of various driving modules can be unified in advance, and all driving modules generate driving currents close to a current corresponding to a target brightness in the first frame after switching an image, thereby making the brightness of the display panel close to the target brightness in the first frame after switching the image.

Based on the above embodiments, the phases that the driving method may also include are described below.

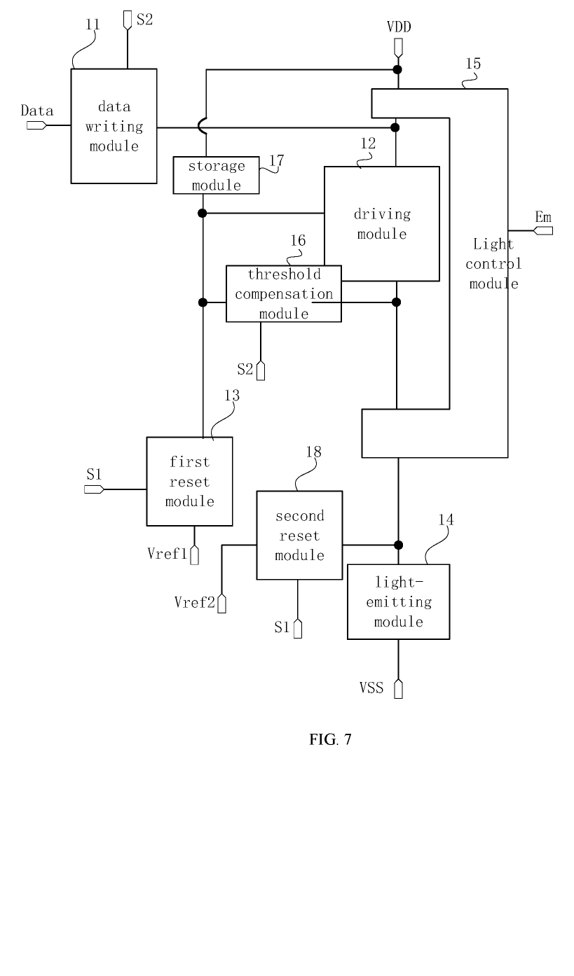

FIG. 7 is a structural schematic diagram of another pixel circuit provided by an embodiment of the present application. In an embodiment, as shown in FIG. 7, the pixel circuit further includes a light-emitting module 14, and the driving module 12 is connected to the light-emitting module 14.

In an embodiment, as shown in FIG. 7, the pixel circuit further includes a light-emitting control module 15, the light-emitting control module 15 is connected between the first power source VDD and the light-emitting module 14, a control terminal of the light-emitting control module 15 is connected to a third gate driving line Em, and a third gate driving signal EM provided by the third gate driving line Em is used to control a turn-on and a turn-off of the light-emitting control module 15.

In an embodiment, within one display frame, the driving method for the pixel circuit further includes:

in a light-emitting phase, the driving module generates a driving current, to cause the light-emitting module to emit light in response to the driving current.

As shown in FIG. 6, in a light-emitting phase t15, a third gate signal EM is at an effective level, controlling the light-emitting control module 15 to be turned on, and the first power source VDD, the driving module 12, the light-emitting control module 15, the light-emitting module 14 and the second power source VSS form a current loop, the driving module 12 generates a driving current, and the light-emitting module 14 emits light in response to the driving current.

In an embodiment, as shown in in FIG. 7, the pixel circuit further includes a threshold compensation module 16, a control terminal of the threshold compensation module 16 is connected to the second gate driving line S2, and the threshold compensation module 16 is connected between a second terminal of the driving module 12 and the control terminal of the driving module 12.

FIG. 7 shows a case where the data writing module 11 is connected to a first terminal of the driving module 12. When the second gate driving signal Scan2 provided by the second gate driving line S2 is at an effective level, the data writing module 11 and the threshold compensation module 16 are turned on, and the data writing module 11 transmits a data voltage (the first data voltage or the second data voltage) to the control terminal of the driving module 12 through the driving module 12 and the threshold compensation module 16, thereby achieving writing the data voltage (the first data voltage or the second data voltage) to the control terminal of the driving module 12.

In an embodiment, as shown in FIG. 7, the pixel circuit further includes a storage module 17, a first terminal of the storage module 17 is connected to a DC signal, and a second terminal of the storage module 17 is connected to the control terminal of the driving module 12. In an embodiment, the first terminal of the storage module 17 is connected to the first power source VDD. Since a potential of the first terminal of the storage module 17 remains unchanged, the potential of the control terminal of the driving module 12 can be maintained.

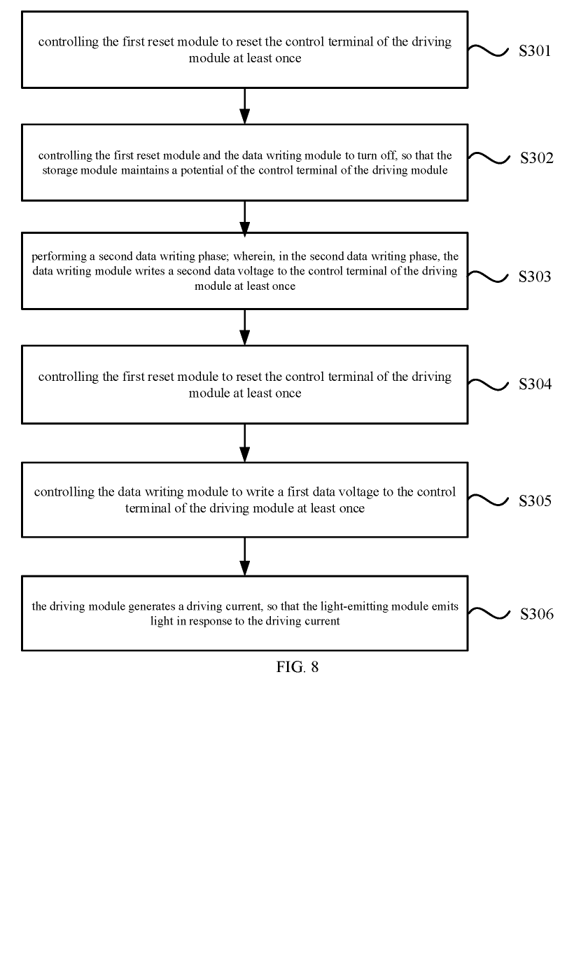

FIG. 8 is a flowchart of another driving method for a pixel circuit provided by an embodiment of the present application. In an embodiment, referring to FIG. 8, within one display frame, the driving method for the pixel circuit includes:

S301, in a first reset phase, controlling the first reset module to reset the control terminal of the driving module at least once.

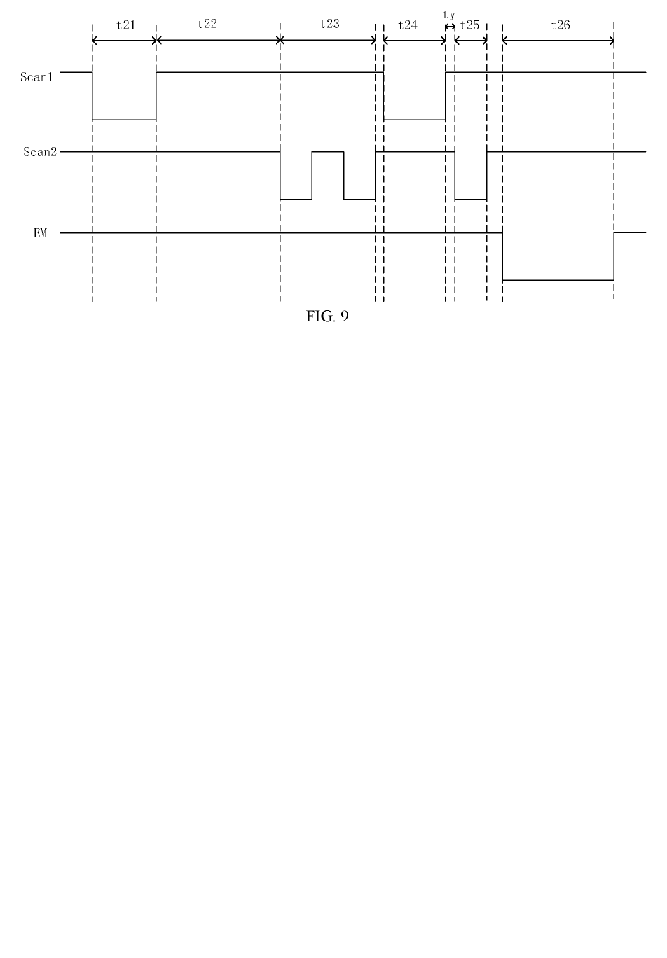

FIG. 9 is another driving timing diagram of a pixel circuit provided by an embodiment of the present application. As shown in FIG. 9, in the first reset phase t21, the first gate driving signal Scan1 on the first gate driving line S1 is at an effective level, the first reset module 13 is turned on, and resets the control terminal of the driving module 12.

S302, in a reset maintaining phase, controlling the first reset module and the data writing module to turn off, to cause the storage module to maintain a potential of the control terminal of the driving module.

In an embodiment, as shown in FIG. 9, in a reset maintaining phase t22, the first gate driving signal Scan1 and the second gate driving signal Scan2 are both at an ineffective level, and the first reset module 13 and the data writing module 11 are turned off. Because the first reset voltage is written to the control terminal of the driving module 12 in the first reset phase t21, the storage module 17 can maintain the potential of the control terminal of the driving module 12, thereby continuously applying a positive voltage stress to the driving module 12. The driving module 12 can better recover characteristics, and even the driving module 12 with a large characteristic shift can well recover characteristics, facilitating the driving current generated by the driving module 12 to approach or equal the current corresponding to a target brightness, thereby improving the display effect of the display panel.

A duration of the reset maintaining phase may be adjusted according to an actual requirement, in an embodiment, adjusted according to a degree of an afterimage of the display panel or a degree of a characteristic shift of the driving module 12, and the driving method can be applied to different working states, improving an applicability of the driving method for the pixel circuit.

S303, performing a second data writing phase; and, in the second data writing phase, the data writing module writes a second data voltage to the control terminal of the driving module at least once.

As shown in FIG. 9, in the second data writing phase t23, the second gate driving signal Scan2 on the second gate driving line S2 has two effective levels, controlling the data writing module 11 to be turned on twice, and the data writing module 11 transmits the second data voltage to the control terminal of the driving module 12 twice.

S304, in a second reset phase, controlling the first reset module to reset the control terminal of the driving module at least once.

As shown in FIG. 9, in the second reset phase t24, the first gate driving signal Scan1 on the first gate driving line S1 is at an effective level, the first reset module 13 is turned on, and resets the control terminal of the driving module 12.

S305, in a first data writing phase, controlling the data writing module to write a first data voltage to the control terminal of the driving module at least once.

As shown in FIG. 9, in the first data writing phase t25, the second gate driving signal Scan2 on the second gate driving line S2 is at an effective level, controlling the data writing module 11 to be turned on, and the data writing module 11 transmits the first data voltage on the data line Data to the control terminal of the driving module 12.

S306, in a light-emitting phase, the driving module generates a driving current, to cause the light-emitting module to emit light in response to the driving current.

As shown in FIG. 9, in the light-emitting phase t26, the third gate signal EM is at an effective level, controlling the light-emitting control module 15 to be turned on, and the first power source VDD, the driving module 12, the light-emitting control module 15, the light-emitting module 14 and the second power source VSS form a current loop, the driving module 12 generates a driving current according to the first data voltage, and the light-emitting module 14 emits light in response to the driving current.

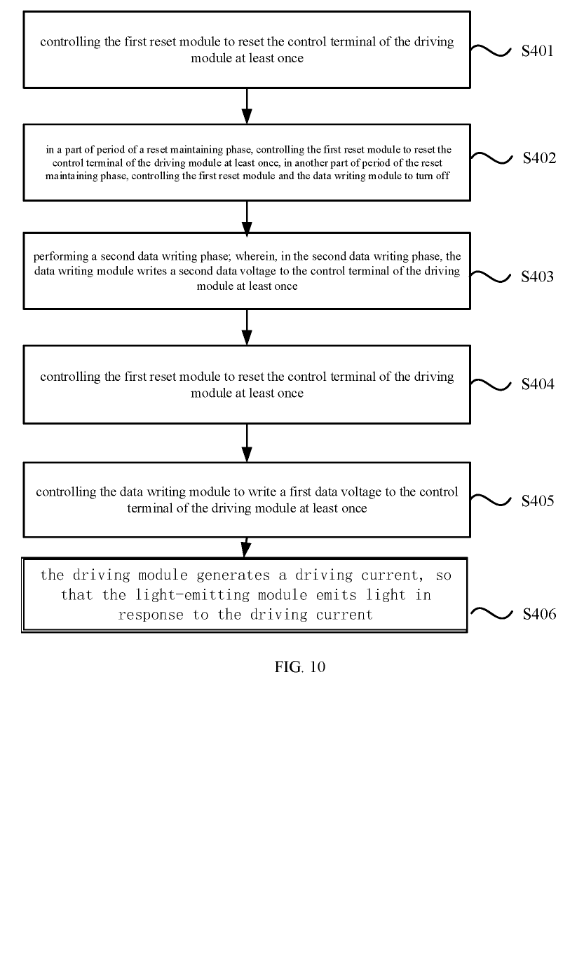

In another embodiment, FIG. 10 is a flowchart of another driving method for a pixel circuit provided by an embodiment of the present application. In an embodiment, referring to FIG. 10, within one display frame, the driving method for the pixel circuit includes:

S401, in a first reset phase, controlling the first reset module to reset the control terminal of the driving module at least once.

S402, in a part of a period of a reset maintaining phase, controlling the first reset module to reset the control terminal of the driving module at least once, and in another part of a period of the reset maintaining phase, controlling the first reset module and the data writing module to turn off; and the another part of the period is a period from an end of a last reset of the control terminal of the driving module by the first reset module in the reset maintaining phase to a start of a second data writing phase.

In an embodiment, by controlling the first reset module 13 to reset the control terminal of the driving module 12 at least once in a part of a period of the reset maintaining phase, the number of times of applying a reverse voltage stress to the driving module 12 can be increased, which can avoid the problem that the storage module 17 cannot well maintain the potential of the control terminal of the driving module 12, resulting in a poor characteristic recovery. Moreover, when the gate driving circuit cannot output an ineffective level for a long period, the duration of the reset maintaining phase can be ensured, ensuring that characteristics of all driving modules 12 are recovered.

In an embodiment, FIG. 11 is another driving timing diagram of a pixel circuit provided by an embodiment of the present application. As shown in FIG. 11, the difference between FIG. 11 and FIG. 9 is that in FIG. 11, in a part of a period t221 of the reset maintaining phase t22, the first gate driving signal Scan1 is at an effective level, controlling the first reset module 13 to reset the control terminal of the driving module 12 at least once; in the remaining period of the reset phase t22, the first gate driving signal Scan1 and the second gate driving signal Scan2 are both at an ineffective level, and the first reset module 13 and the data writing module 11 are turned off. Another part of a period t222 is a period between the part of the period t221 and the second data writing phase t23. It should be noted that the period when the first gate driving signal Scan1 is at an effective level in the reset phase t22 may be a beginning part of the reset maintaining phase t22, may also be a middle part of the reset maintaining phase t22, or may also be a part before an end of the reset maintaining phase t22.

S403, performing a second data writing phase; and, in the second data writing phase, the data writing module writes a second data voltage to the control terminal of the driving module at least once.

S404, in a second reset phase, controlling the first reset module to reset the control terminal of the driving module at least once.

S405, in a first data writing phase, controlling the data writing module to write a first data voltage to the control terminal of the driving module at least once.

S406, in a light-emitting phase, the driving module generates a driving current, to cause the light-emitting module to emit light in response to the driving current.

In one embodiment of the present embodiment, by setting a reset maintaining phase after the first reset phase, the duration of applying a reverse voltage stress to the driving module can be increased, which can ensure a characteristic recovery of the driving module. Moreover, the duration of the reset maintaining phase can be adjusted according to a degree of an afterimage of the display panel, thereby improving an applicability of the driving method for the pixel circuit.

In some other embodiments, various phases in the driving timing of the pixel circuit may be performed in other orders, and another possible execution order is described below.

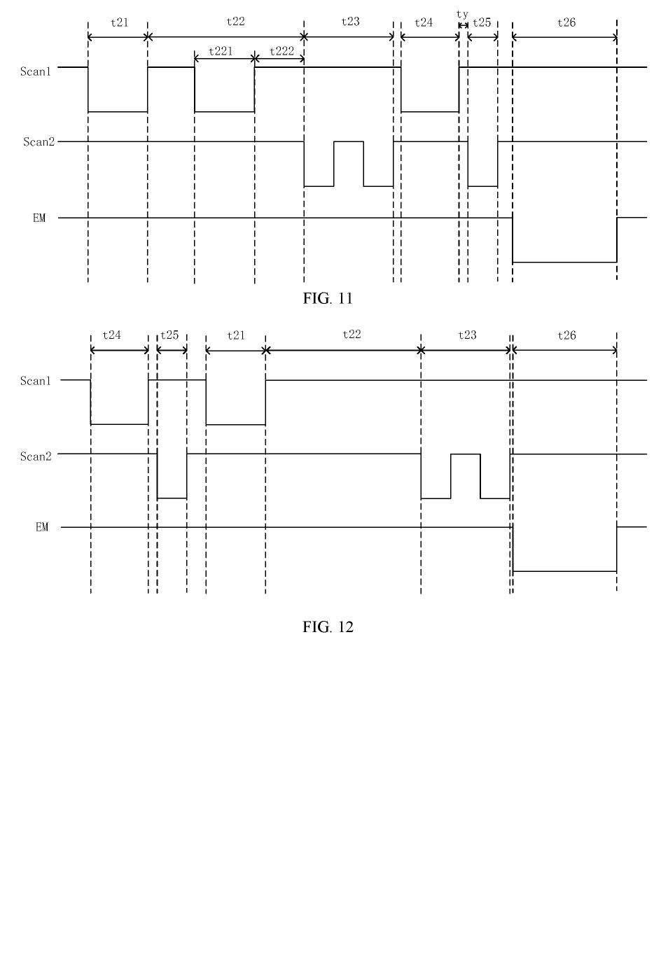

In an embodiment, the first data writing phase may also be located before the first reset phase; and the second reset phase is located before the first data writing phase; in the first data writing phase, the data writing module 11 writes the second data voltage to the control terminal of the driving module 12 at least once; and in the second data writing phase, the data writing module 11 writes the first data voltage to the control terminal of the driving module 12 at least once. In an embodiment, FIG. 12 is another driving timing diagram of a pixel circuit provided by an embodiment of the present application. As shown in FIG. 12, the difference between FIG. 12 and FIG. 9 is that the first data writing phase t25 in FIG. 12 is located before the first reset phase t21.

In an embodiment, when the first data writing phase t25 is located before the first reset phase t21, an execution order of the driving method is the second reset phase t24, the first data writing phase t25, the first reset phase t21, the reset maintaining phase t22, the second data writing phase t23 and the light-emitting phase t26. In this way, in the second reset phase t24, the control terminal of the driving module 12 can be reset, a reverse voltage stress can be applied to the driving module 12, and characteristics of the driving module 12 can be improved. Then in the first data writing phase t25, the second data voltage is transmitted to the control terminal of the driving module 12, a current stress is applied to the driving module 12, and characteristics of the driving module 12 are improved. Then the first reset phase t21 and the reset maintaining phase t22 are performed to improve characteristics of the driving module 12, and characteristics of all driving modules 12 can be recovered. In the second data writing phase t23, the first data voltage is written to the driving module 12 after a characteristic recovery, and the driving current generated by the driving module 12 according to the first data voltage can be the same as the current corresponding to a target brightness, thereby improving the display effect of the display panel.

Based on the some embodiments, in an embodiment, before the reset maintaining phase, the driving method for the pixel circuit further includes:

determining a duration of the reset maintaining phase according to a test parameter value of the display panel where the pixel circuit is located; and the test parameter value at least includes an afterimage value of the display panel.

In an embodiment, by measuring a brightness difference of the display panel before and after switching when the display panel switches from a non-solid color image to a solid color image, the afterimage value of the display panel can be determined. During a test, the duration of the reset maintaining phase corresponding to a case where the afterimage value is well improved can be tested, and a corresponding relationship between the afterimage value and the duration of the reset maintaining phase can be stored. When driving the pixel circuit, if the display panel switches from a non-solid color image to a solid color image, a brightness value of the display panel can be obtained, and then the afterimage value of the display panel can be determined. According to the corresponding relationship between the afterimage value and the duration of the reset maintaining phase, the duration of the reset maintaining phase can be determined. In this way, the duration of the reset maintaining phase determined according to the afterimage value can better improve characteristics of the driving module. Under any working condition, a degree of an afterimage can be reduced to a greater extent, and when switching to a next image, a first frame brightness can be well improved, and the first frame brightness is closer to a target brightness.

Based on the some embodiments, the phases that the driving method may also include are described below. In an embodiment, as shown in FIG. 6, FIG. 9 or FIG. 11, between the second reset phase and the first data writing phase, the driving method for the pixel circuit further includes:

in a transition phase, controlling the data writing module 11 and the first reset module 13 to turn off; and a duration of the reset maintaining phase is greater than a duration of the transition phase.

In an embodiment, as shown in FIG. 6, FIG. 9 or FIG. 11, in a transition phase ty, the first gate driving signal Scan1 and the second gate driving signal Scan2 are both at an ineffective level. Because in the first reset phase, the reset maintaining phase and the second reset phase, a reverse voltage stress has been applied to the driving module 12 for a long time, which can improve a bias state of the driving module 12, and there is no need for a long time of a reset maintaining in the transition phase ty, which can avoid a long time of the non-light-emitting phase. Moreover, by setting the duration of the reset maintaining phase to be greater than the duration of the transition phase, in an embodiment, the duration of the reset maintaining phase is much greater than the duration of the transition phase, that is, the duration of the reset maintaining phase is long, ensuring that the reset maintaining phase can improve characteristics of all driving modules 12, and even the driving module 12 with a large characteristic shift can well perform a characteristic recovery.

In an embodiment, as shown in FIG. 11, a duration of another part of a period t222 is greater than a duration of the transition phase ty. In this way, it can be ensured that the reset maintaining phase maintains a reset for the driving module 12 for a long period, ensuring an effect of improving the bias state of the driving module 12, and the transition phase ty does not need to maintain a reset for a long time, which can avoid a long time of the non-light-emitting phase.

Based on the some embodiments, in some embodiments, in an embodiment, between the first reset phase and the reset maintaining phase, the driving method for the pixel circuit further includes performing at least one first reset phase. In this way, the number of times and a duration of applying a reverse voltage stress to the driving module 12 can be increased, improving characteristics of the driving module 12, and the driving module 12 with a large characteristic shift can also well perform a characteristic recovery, thereby making a characteristic recovery of all driving modules 12 consistent, which is beneficial to improving a display uniformity of the display panel.

In some embodiments, between the reset maintaining phase and the second data writing phase, the driving method for the pixel circuit further includes performing at least one first reset phase and at least one reset maintaining phase. In this way, characteristics of the driving module 12 can be improved to a greater extent, and the driving module 12 with a large characteristic shift can also well perform a characteristic recovery, thereby making a characteristic recovery of all driving modules 12 consistent, which is beneficial to improving a display uniformity of the display panel.

Based on the some embodiments, the phases that the driving method may also include are described below.

In an embodiment, as shown in FIG. 7, the pixel circuit further includes a second reset module 18, and the second reset module 18 is connected to the light-emitting module 14; in an embodiment, a control terminal of the second reset module 18 is connected to the first gate driving line S1, a first terminal of the second reset module 18 is connected to a second reset voltage Vref2, and a second terminal of the second reset module 18 is connected to a first terminal of the light-emitting module 14.

In an embodiment, the driving method for the pixel circuit further includes:

in the first reset phase, controlling the second reset module to reset the light-emitting module 14 at least once;

in the second reset phase, controlling the second reset module to reset the light-emitting module 14 at least once.

In an embodiment, in the first reset phase, the first gate driving signal Scan1 is at an effective level, controlling the second reset module 18 to be turned on, and the second reset module 18 transmits the second reset voltage Vref2 to the first terminal of the light-emitting module 14, to reset the light-emitting module 14 at least once. In the second reset phase, the first gate driving signal Scan1 is at an effective level, controlling the second reset module 18 to be turned on, and the second reset module 18 resets the light-emitting module 14 at least once. Thus, a residual charge at the first terminal of the light-emitting module 14 can be cleared, and the light-emitting module 14 can more accurately display a target brightness.

A voltage difference between the second reset voltage Vref2 and the voltage at the second terminal of the light-emitting module 14 (the voltage of the second power source VSS) is smaller than a turn-on voltage of the light-emitting module 14.

Based on the some embodiments, in an embodiment, a single effective pulse width of a control signal of the first reset module 13 is the same in each instance;

a single effective pulse width of a control signal of the first reset module 13 is n times a single effective pulse width of a control signal of the data writing module.

The control signal of the first reset module 13 is the first gate driving signal. The control signal of the first reset module 13 is the same control signal, and a single effective pulse width on the same control signal is the same in each instance. The control signal of the data writing module 11 is the second gate driving signal.

In an embodiment, in the first reset phase and the second reset phase, the first reset module responds to the first gate driving signal, so a single effective pulse width of the first reset phase and the second reset phase is the same. Because a plurality of pixel circuits are arranged in an array, when performing a data writing, data is written row by row, so a single effective pulse width of a control signal of the data writing module 11 is at most one row time, that is, the single effective pulse width of the control signal of the data writing module 11 is less than or equal to one row time. When resetting the control terminal of the driving module 12, a reset can be performed row by row, or at least two rows can be reset simultaneously, that is, a single effective pulse width of a control signal of the first reset module (the first gate driving signal) can be one row time, two row times, or multiple row times. Therefore, the single effective pulse width of the control signal of the first reset module 13 is n times the single effective pulse width of the control signal of the data writing module 11. When the single effective pulse width of the control signal of the data writing module 11 is equal to one row time, n is an integer. When the single effective pulse width of the control signal of the data writing module 11 is less than one row time, n may not be an integer. In this way, the number of first gate driving signals can be reduced, the number of gate driving circuits can be reduced, which is beneficial to reducing a space.

In an embodiment, n is an integer greater than or equal to 1. At this time, the single effective pulse width of the control signal of the data writing module 11 is equal to one row time, which can achieve a sufficient data writing and ensure that a data voltage (the first data voltage or the second data voltage) is completely written to the driving module 12.

In an embodiment, n is 1 or 2.

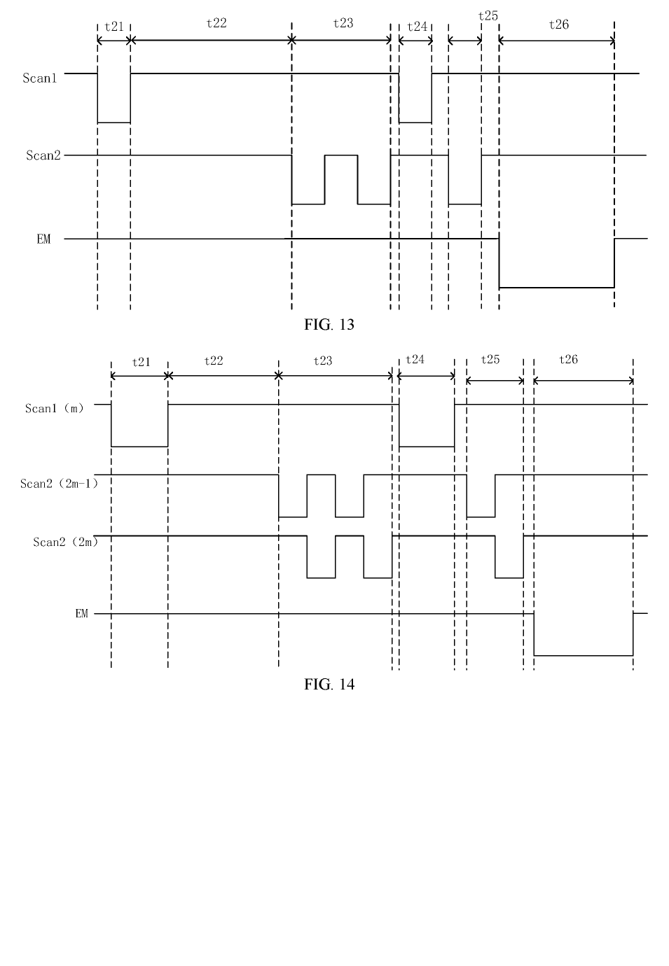

In one embodiment, FIG. 13 is another driving timing diagram of a pixel circuit provided by an embodiment of the present application. As shown in FIG. 13, a single effective pulse width of a control signal of the first reset module 13 (the first gate driving signal Scan1) is the same as a single effective pulse width of a control signal of the data writing module 11 (the second gate driving signal Scan2), that is, the single effective pulse width of the control signal of the first reset module 13 (the first gate driving signal Scan1) is 1 times the single effective pulse width of the control signal of the data writing module 11 (the second gate driving signal Scan2).

In another embodiment, FIG. 14 is another driving timing diagram of a pixel circuit provided by an embodiment of the present application. As shown in FIG. 14, a single effective pulse width of a control signal of the first reset module 13 (the first gate driving signal Scan1) is 2 times a single effective pulse width of a control signal of the data writing module 11 (the second gate driving signal Scan2), and the first gate driving signal Scan1 can simultaneously drive the first reset modules 13 in two rows of pixel circuits to be turned on, which can reduce the number of gate driving circuits and save a space.

In some other embodiments, n may also be an integer greater than or equal to 3, so the first gate driving signal can simultaneously drive first reset modules in multiple rows of pixel circuits to be turned on, reducing the number of gate driving circuits.

As shown in FIG. 14, when n is 2, one first gate driving signal Scan1 corresponds to two rows of pixel circuits, and one second gate driving signal Scan2 corresponds to one row of pixel circuits. Then a (2m-1)th row of pixel circuits and a 2m-th row of pixel circuits correspond to an m-th first gate driving signal Scan1(m), the (2m-1)th row of pixel circuits corresponds to a (2m-1)th second gate driving signal Scan2(2m-1), and the 2m-th row of pixel circuits corresponds to a 2m-th second gate driving signal Scan2(2m). In the first data writing phase t24, the (2m-1)th second gate driving signal Scan2(2m-1) and the 2m-th second gate driving signal Scan2(2m) sequentially output an effective level. In the second data writing phase t23, if the second data voltage is written to the control terminal of the driving module 12 only once, the (2m-1)th second gate driving signal Scan2(2m-1) and the 2m-th second gate driving signal Scan2(2m) sequentially output an effective level. In the second data writing phase t23, if the second data voltage is written to the control terminal of the driving module 12 at least twice, the (2m-1)th second gate driving signal Scan2(2m-1) and the 2m-th second gate driving signal Scan2(2m) alternately output an effective level. That is, when writing a data voltage (the first data voltage or the second data voltage) at least twice, the data voltage (the first data voltage or the second data voltage) is alternately written to two adjacent rows of pixel circuits, achieving a data writing to two adjacent rows of pixel circuits. And m is an integer greater than or equal to 1.

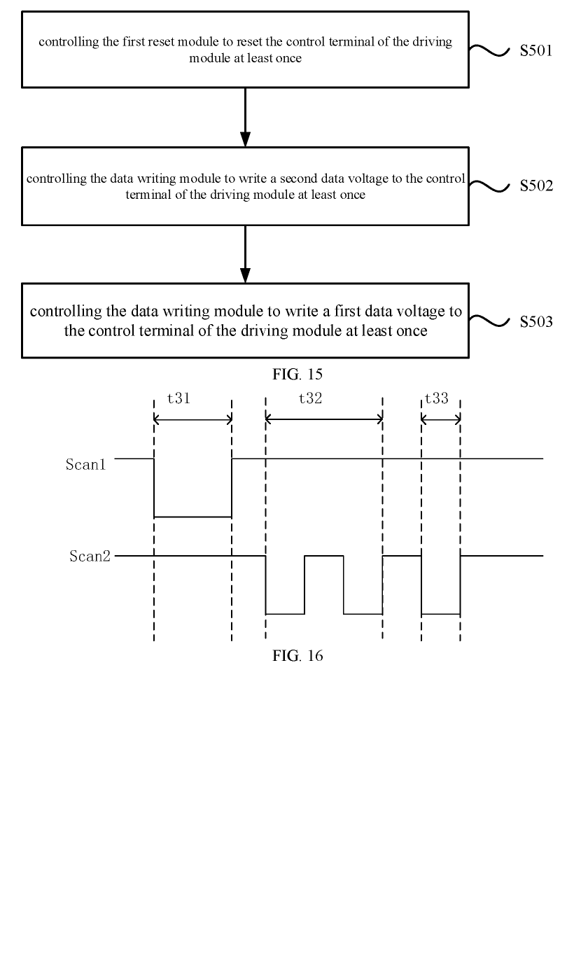

In another embodiment, FIG. 15 is a flowchart of another driving method for a pixel circuit provided by an embodiment of the present application. Referring to FIG. 15, within one display frame, the driving method for the pixel circuit includes:

S501, in a first reset phase, controlling the first reset module to reset the control terminal of the driving module at least once.

In an embodiment, FIG. 16 is another driving timing diagram of a pixel circuit provided by an embodiment of the present application. As shown in FIG. 16, in a first reset phase t31, the first gate driving signal Scan1 on the first gate driving line S1 is at an effective level, controlling the first reset module 13 to be turned on at least once, and the first reset module 13 transmits the first reset voltage Vref1 to the control terminal of the driving module 12 at least once, to reset the control terminal of the driving module 12 at least once. In this way, a residual charge from a previous frame can be cleared, and a reverse voltage stress (opposite to a voltage stress when the driving module 12 is turned on) can be applied to the driving module 12, thereby improving characteristics of the driving module 12, and avoiding an afterimage problem caused by a characteristic change when the driving module 12 is turned on in the previous frame, which is beneficial to improving the display effect of the display panel where the pixel circuit is located. Moreover, in the first reset phase, the first reset module 13 may reset the control terminal of the driving module 12 multiple times, thereby applying the reverse voltage stress to the driving module 12 multiple times, to better improve the characteristics of the driving module 12. Even the driving module 12 with a large characteristic shift can well recover characteristics, and each driving module 12 can better recover characteristics before generating a driving current.

S502, in a second data writing phase, controlling the data writing module to write a second data voltage to the control terminal of the driving module at least once.

In an embodiment, as shown in FIG. 16, in a second data writing phase t32, the second gate driving signal Scan2 on the second gate driving line S2 is at an effective level at least once, controlling the data writing module 11 to be turned on at least once, and the data writing module 11 transmits the second data voltage to the control terminal of the driving module 12 at least once. A voltage of a first terminal of the driving module 12 is a first power voltage, the first power voltage may be a positive voltage, and the second data voltage is a negative voltage, so a current stress can be applied to the driving module 12, and all driving modules 12 are unified in advance in a state under an input of the first data voltage, avoiding large differences in driving currents generated by the driving modules 12 under the same gray level, which can improve a display uniformity. By applying the current stress to the driving module 12 to improve the characteristics of the driving module 12, it is also possible to avoid a large difference between the driving current generated by the driving module 12 and the driving current corresponding to a target brightness in a first frame after switching an image, avoiding a large difference between a first frame brightness and the target brightness after switching the image, which can improve the display effect of the display panel.

S503, in a first data writing phase, controlling the data writing module to write a first data voltage to the control terminal of the driving module at least once.

In an embodiment, as shown in FIG. 16, in a first data writing phase t33, the second gate driving signal Scan2 on the second gate driving line S2 is at an effective level, controlling the data writing module 11 to be turned on, and the data writing module 11 transmits the first data voltage on the data line Data to the control terminal of the driving module 12, facilitating the driving module 12 to generate a driving current according to the first data voltage, and the light-emitting module 14 to emit light in response to the driving current.

In one embodiment of the present embodiment, by setting the first data writing phase and the second data writing phase, not only can a current stress be applied to the driving module, but also the states of various driving modules can be unified in advance, and all driving modules generate driving currents close to a current corresponding to a target brightness in the first frame after switching an image, thereby making the brightness of the display panel close to the target brightness in the first frame after switching the image.

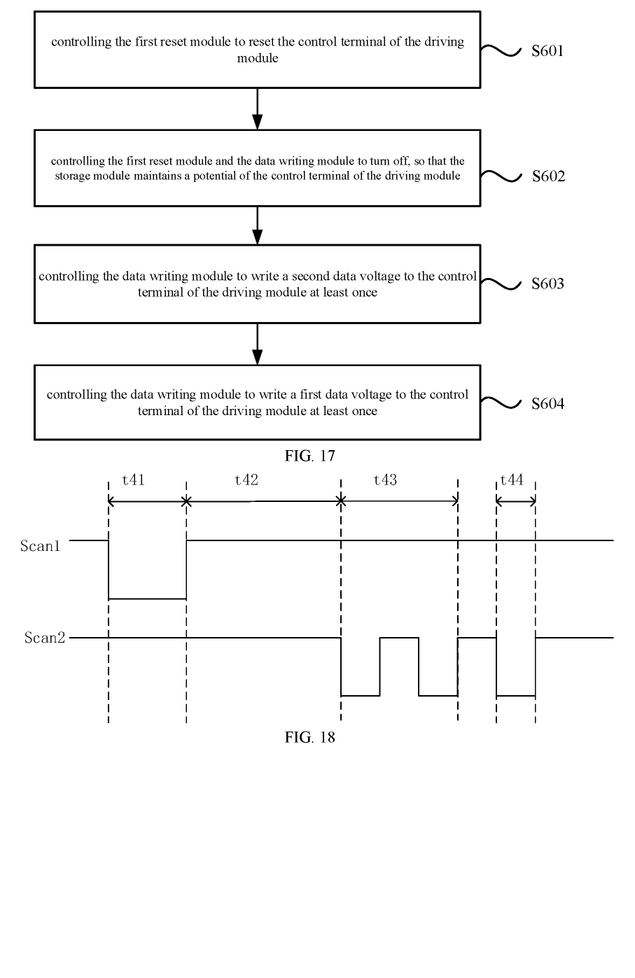

Based on the above embodiments, FIG. 17 is a flowchart of another driving method for a pixel circuit provided by an embodiment of the present application. In an embodiment, referring to FIG. 17, within one display frame, the driving method for the pixel circuit includes:

S601, in a first reset phase, controlling the first reset module to reset the control terminal of the driving module.

FIG. 18 is another driving timing diagram of a pixel circuit provided by an embodiment of the present application. As shown in FIG. 18, in a first reset phase t41, the first gate driving signal Scan1 on the first gate driving line S1 is at an effective level, controlling the first reset module 13 to be turned on at least once, and the first reset module 13 transmits the first reset voltage Vref1 to the control terminal of the driving module 12 at least once, to reset the control terminal of the driving module 12 at least once.

S602, in a reset maintaining phase, controlling the first reset module and the data writing module to turn off, to cause the storage module to maintain a potential of the control terminal of the driving module.

In an embodiment, as shown in FIG. 18, in a reset maintaining phase t42, the first gate driving signal Scan1 and the second gate driving signal Scan2 are both at an ineffective level, and the first reset module 13 and the data writing module 11 are turned off. Because the first reset voltage is written to the control terminal of the driving module 12 in the first reset phase t41, the storage module 17 can maintain the potential of the control terminal of the driving module 12, thereby continuously applying a positive voltage stress to the driving module 12. The driving module 12 can better recover characteristics, and even the driving module 12 with a large characteristic shift can well recover characteristics, facilitating the driving current generated by the driving module 12 to approach or equal the current corresponding to a target brightness, thereby improving the display effect of the display panel.

A duration of the reset maintaining phase may be adjusted according to an actual requirement, in an embodiment, adjusted according to a degree of an afterimage of the display panel or a degree of a shift of the driving module 12, and the driving method can be applied to different working states, improving an applicability of the driving method for the pixel circuit.

S603, in a second data writing phase, controlling the data writing module to write a second data voltage to the control terminal of the driving module at least once.

In an embodiment, as shown in FIG. 18, in a second data writing phase t43, the second gate driving signal Scan2 on the second gate driving line S2 has two effective levels, controlling the data writing module 11 to be turned on twice, and the data writing module 11 transmits the second data voltage to the control terminal of the driving module 12 twice.

S604, in a first data writing phase, controlling the data writing module to write a first data voltage to the control terminal of the driving module at least once.

In an embodiment, as shown in FIG. 18, in a first data writing phase t44, the second gate driving signal Scan2 on the second gate driving line S2 is at an effective level, controlling the data writing module 11 to be turned on, and the data writing module 11 transmits the first data voltage on the data line Data to the control terminal of the driving module 12.

In one embodiment of the present embodiment, by setting a reset maintaining phase after the first reset phase, the duration of applying a reverse voltage stress to the driving module can be increased, which can ensure a characteristic recovery of the driving module. Moreover, the duration of the reset maintaining phase can be adjusted according to a degree of an afterimage of the display panel, thereby improving an applicability of the driving method for the pixel circuit.

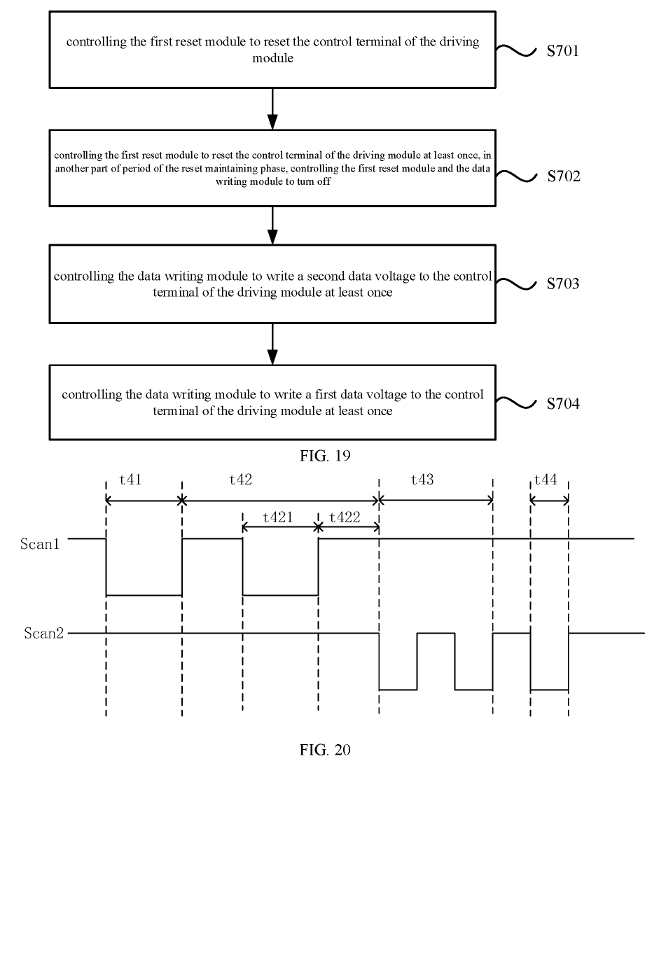

In another embodiment, FIG. 19 is a flowchart of another driving method for a pixel circuit provided by an embodiment of the present application. In an embodiment, referring to FIG. 19, within one display frame, the driving method for the pixel circuit includes:

S701, in a first reset phase, controlling the first reset module to reset the control terminal of the driving module.

S702, in a part of a period of a reset maintaining phase, controlling the first reset module to reset the control terminal of the driving module at least once, and in another part of a period of the reset maintaining phase, controlling the first reset module and the data writing module to turn off; and the another part of the period is a period from an end of a last reset of the control terminal of the driving module by the first reset module in the reset maintaining phase to a start of a second data writing phase.

In an embodiment, FIG. 20 is another driving timing diagram of a pixel circuit provided by an embodiment of the present application. As shown in FIG. 20, the difference between FIG. 20 and FIG. 18 is that in FIG. 20, in a part of a period t421 of the reset maintaining phase t42, the first gate driving signal Scan1 is at an effective level, controlling the first reset module 13 to reset the control terminal of the driving module 12 at least once; in the remaining period of the reset phase t42, the first gate driving signal Scan1 and the second gate driving signal Scan2 are both at an ineffective level, and the first reset module 13 and the data writing module 11 are turned off. Another part of a period t422 is a period between the part of the period t421 and the second data writing phase t43. It should be noted that the period when the first gate driving signal Scan1 is at an effective level in the reset phase t42 may be a beginning part of the reset maintaining phase t42, may also be a middle part of the reset maintaining phase t42, or may also be a part before an end of the reset maintaining phase t42.

By increasing the number of times of applying a reverse voltage stress to the driving module 12, the problem that the storage module 17 cannot well maintain the potential of the control terminal of the driving module 12, resulting in a poor characteristic recovery, can be avoided. Moreover, when the gate driving circuit cannot output an ineffective level for a long period, the duration of the reset maintaining phase can be ensured, ensuring that characteristics of all driving modules 12 are recovered.

S703, in a second data writing phase, controlling the data writing module to write a second data voltage to the control terminal of the driving module at least once.

S704, in a first data writing phase, controlling the data writing module to write a first data voltage to the control terminal of the driving module at least once.

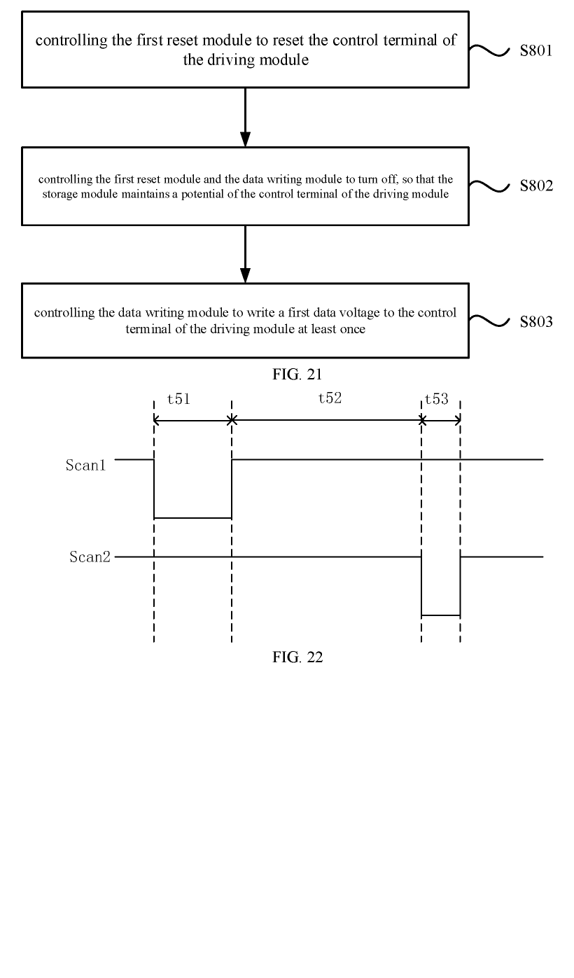

In another embodiment, FIG. 21 is a flowchart of another driving method for a pixel circuit provided by an embodiment of the present application. Referring to FIG. 21, within one display frame, the driving method for the pixel circuit includes:

S801, in a first reset phase, controlling the first reset module to reset the control terminal of the driving module.

FIG. 22 is another driving timing diagram of a pixel circuit provided by an embodiment of the present application. As shown in FIG. 22, in a first reset phase t51, the first gate driving signal Scan1 on the first gate driving line S1 is at an effective level, controlling the first reset module 13 to be turned on at least once, and the first reset module 13 transmits the first reset voltage Vref1 to the control terminal of the driving module 12 at least once, to reset the control terminal of the driving module 12 at least once.

S802, in a reset maintaining phase, controlling the first reset module and the data writing module to turn off, to cause the storage module to maintain a potential of the control terminal of the driving module.

In an embodiment, as shown in FIG. 22, in a reset maintaining phase t52, the first gate driving signal Scan1 and the second gate driving signal Scan2 are both at an ineffective level, and the first reset module 13 and the data writing module 11 are turned off. Because the first reset voltage is written to the control terminal of the driving module 12 in the first reset phase t51, the storage module 17 can maintain the potential of the control terminal of the driving module 12, thereby continuously applying a positive voltage stress to the driving module 12. The driving module 12 can better recover characteristics, and even the driving module 12 with a large characteristic shift can well recover characteristics, facilitating the driving current generated by the driving module 12 to approach or equal the current corresponding to a target brightness, thereby improving the display effect of the display panel.

A duration of the reset maintaining phase may be adjusted according to an actual requirement, in an embodiment, adjusted according to a degree of an afterimage of the display panel or a degree of a shift of the driving module 12, and the driving method can be applied to different working states, improving an applicability of the driving method for the pixel circuit.

S803, in a first data writing phase, controlling the data writing module to write a first data voltage to the control terminal of the driving module at least once.

As shown in FIG. 22, in a first data writing phase t53, the second gate driving signal Scan2 on the second gate driving line S2 is at an effective level, controlling the data writing module 11 to be turned on, and the data writing module 11 transmits the first data voltage on the data line Data to the control terminal of the driving module 12.

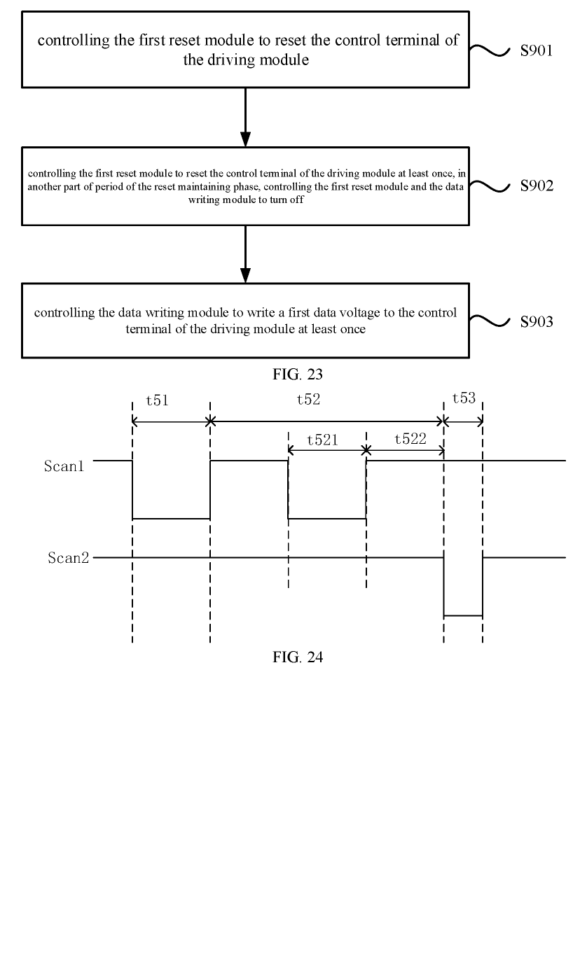

In another embodiment, FIG. 23 is a flowchart of another driving method for a pixel circuit provided by an embodiment of the present application. Referring to FIG. 23, within one display frame, the driving method for the pixel circuit includes:

S901, in a first reset phase, controlling the first reset module to reset the control terminal of the driving module.

S902, in a part of a period of a reset maintaining phase, controlling the first reset module to reset the control terminal of the driving module at least once, and in another part of a period of the reset maintaining phase, controlling the first reset module and the data writing module to turn off; and the another part of the period is a period from an end of a last reset of the control terminal of the driving module by the first reset module in the reset maintaining phase to a start of a first data writing phase.

In an embodiment, FIG. 24 is another driving timing diagram of a pixel circuit provided by an embodiment of the present application. As shown in FIG. 24, the difference between FIG. 24 and FIG. 22 is that in FIG. 24, in a part of a period t521 of the reset maintaining phase t52, the first gate driving signal Scan1 is at an effective level, controlling the first reset module 13 to reset the control terminal of the driving module 12 at least once; in the remaining period of the reset phase t52, the first gate driving signal Scan1 and the second gate driving signal Scan2 are both at an ineffective level, and the first reset module 13 and the data writing module 11 are turned off. Another part of a period t522 is a period between the part of the period t521 and the first data writing phase t53. It should be noted that the period when the first gate driving signal Scan1 is at an effective level in the reset phase t52 may be a beginning part of the reset maintaining phase t52, may also be a middle part of the reset maintaining phase t52, or may also be a part before an end of the reset maintaining phase t52.

By increasing the number of times of applying a reverse voltage stress to the driving module 12, the problem that the storage module 17 cannot well maintain the potential of the control terminal of the driving module 12, resulting in a poor characteristic recovery, can be avoided. Moreover, when the gate driving circuit cannot output an ineffective level for a long period, the duration of the reset maintaining phase can be ensured, ensuring that characteristics of all driving modules 12 are recovered.

S903, in a first data writing phase, controlling the data writing module to write a first data voltage to the control terminal of the driving module at least once.

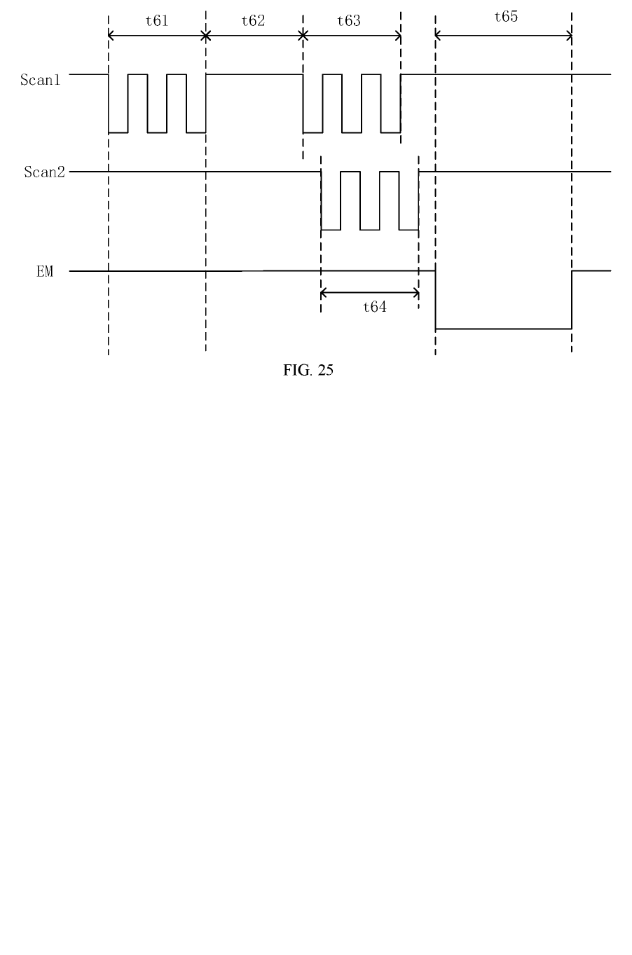

In some embodiments, FIG. 25 is another driving timing diagram of a pixel circuit provided by an embodiment of the present application. As shown in FIG. 25, a single effective pulse width of the first gate driving signal Scan1 is the same as a single effective pulse width of the second gate driving signal Scan2. As shown in FIG. 25, within one display frame, the driving timing of the pixel circuit includes the following phases.

In a first reset phase t61, the first gate driving signal Scan1 transmits an effective level to the first reset module 13 three times, controlling the first reset module 13 to reset the control terminal of the driving module 12 three times.

In a reset maintaining phase t62, the first gate driving signal Scan1 and the second gate driving signal Scan2 are both at an ineffective level, controlling the first reset module 13 and the data writing module 11 to turn off.

In a second reset phase t63, the first gate driving signal Scan1 transmits an effective level to the first reset module 13 three times, controlling the first reset module 13 to reset the control terminal of the driving module 12 three times.

In a first data writing phase t64, the second gate driving signal Scan2 transmits an effective level to the data writing module 11 three times, controlling the data writing module 11 to write the first data voltage to the control terminal of the driving module 12 three times. And when both the second reset phase t63 and the first data writing phase t64 include multiple effective levels, the second reset phase t63 and the first data writing phase t64 may be performed alternately, in the second reset phase t63 and the first data writing phase t64, the first gate driving signal Scan1 and the second gate driving signal Scan2 alternately output an effective level.

In a light-emitting phase t65, the third gate signal EM is at an effective level, controlling the light-emitting control module 15 to be turned on, and the first power source VDD, the driving module 12, the light-emitting control module 15, the light-emitting module 14 and the second power source VSS form a current loop, the driving module 12 generates a driving current, and the light-emitting module 14 emits light in response to the driving current.

In the first reset phase t61 and the second reset phase t63, the control terminal of the driving module 12 is reset multiple times, and in the reset maintaining phase t62, an electrical stress applied to the driving module 12 is maintained, and the control terminal of the driving module 12 is subjected to a negative gate bias stress (NBS) for a long time, reducing an influence of a positive gate bias stress (PBS) caused by a long-time conduction of the driving module 12 in a previous frame display process, and characteristics of the driving module 12 can be recovered before the light-emitting phase, thereby improving the display effect of the display panel. Moreover, the reset process of the control terminal of the driving module 12 is separated from the data writing process, avoiding an invalid reset situation.

The timing diagrams provided in the embodiments of the present application all illustrate an effective level as a low level and an ineffective level as a high level. In some other embodiments, an effective level may also be a high level, and an ineffective level may also be a low level.

Embodiments of the present application further provide a display panel, and the display panel includes a plurality of first gate driving circuits 21, a plurality of second gate driving circuits 22 and a plurality of pixel circuits 10; the pixel circuit 10 includes a data writing module 11, a driving module 12 and a first reset module 13; the data writing module 11 is connected to the driving module 12, and the first reset module 13 is connected to a control terminal of the driving module 12.

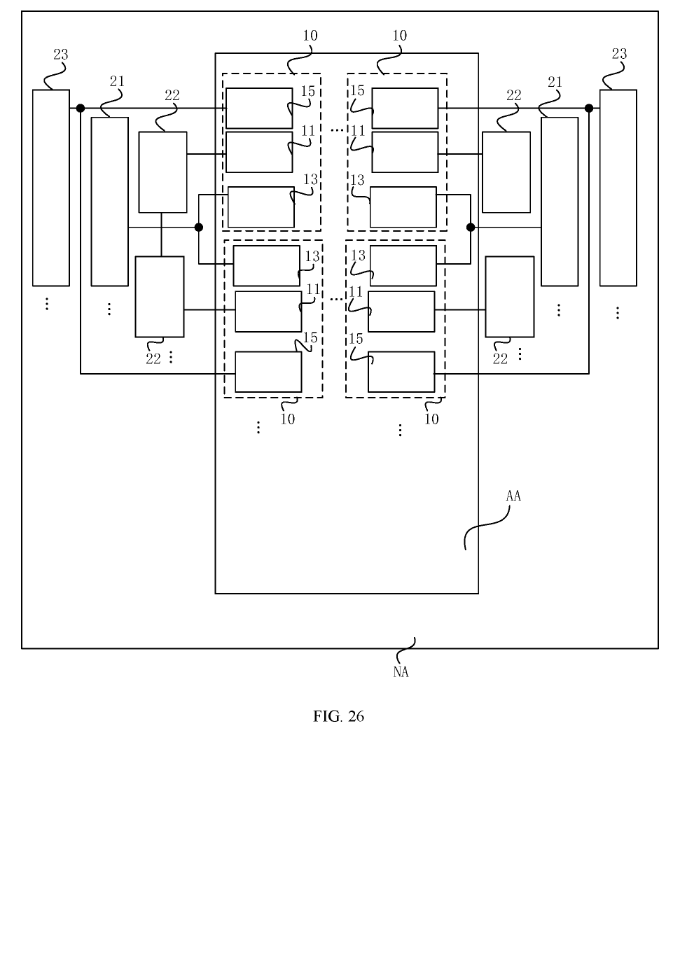

FIG. 26 is a structural schematic diagram of a display panel provided by an embodiment of the present application. Referring to FIG. 26, one first gate driving circuit 21 is connected to first reset modules 13 of k rows of pixel circuits 10, and the first gate driving circuit 21 is configured to transmit a first gate driving signal Scan1 to the first reset modules 13 of corresponding k rows of pixel circuits 10;

one second gate driving circuit 22 is connected to data writing modules 11 of one row of pixel circuits 10, and the second gate driving circuit 22 is configured to transmit a second gate driving signal Scan2 to the data writing modules 11 of a corresponding one row of pixel circuits 10;

a single effective pulse width of the first gate driving signal Scan1 is n times a single effective pulse width of the second gate driving signal Scan2.

In an embodiment, one second gate driving circuit 22 is connected to data writing modules 11 of one row of pixel circuits 10, and the second gate driving signal output by the second gate driving circuit 22 drives the data writing modules 11 in one row of pixel circuits 10, achieving a row-by-row writing of a data voltage (the first data voltage or the second data voltage). The first gate driving circuit 21 is connected to first reset modules 13 of k rows of pixel circuits 10, and can simultaneously transmit the first gate driving signal Scan1 to k rows of pixel circuits 10, which can reduce the number of first gate driving signals Scan1, reduce the number of first gate driving circuits 21, and is beneficial to reducing an occupied area. The second gate driving circuit 22 is connected to data writing modules 11 of one row of pixel circuits 10, the second gate driving signal Scan2 may be the same as one row time, or may be less than one row time, that is, a single effective pulse width of the second gate driving signal Scan2 is less than or equal to one row time. And a single effective pulse width of the first gate driving signal Scan1 is k times one row time, then when the single effective pulse width of the second gate driving signal Scan2 is equal to one row time, n is the same as k. When the single effective pulse width of the second gate driving signal Scan2 is less than one row time, n is greater than k, and n is not an integer.

In one embodiment, in an embodiment, k=n=2. As shown in FIG. 14, a single effective pulse width of the first gate driving signal Scan1 is twice a single effective pulse width of the second gate driving signal Scan2, and the first gate driving signal can simultaneously drive first reset modules in two rows of pixel circuits to be turned on, which can reduce the number of gate driving circuits and save a space. Moreover, k=n, that is, the single effective pulse width of the second gate driving signal Scan2 is equal to one row time, which can fully write a data voltage (the first data voltage or the second data voltage), ensuring an integrity of writing the data voltage (the first data voltage or the second data voltage).

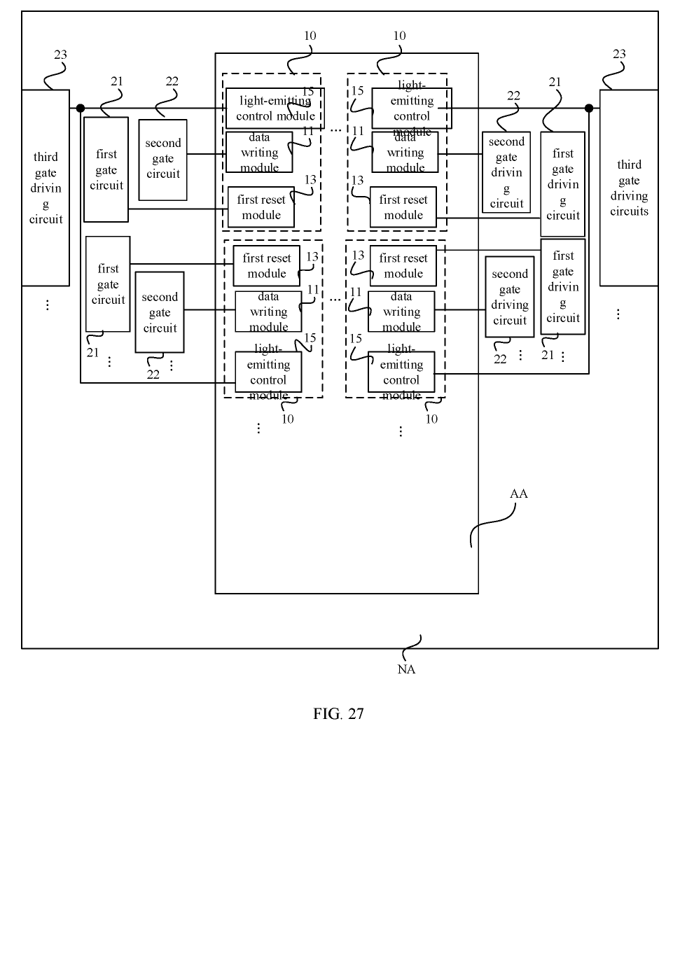

In another embodiment, in an embodiment, k=n=1. FIG. 27 is a structural schematic diagram of another display panel provided by an embodiment of the present application. Referring to FIG. 27, one first gate driving circuit 21 is connected to a first reset module of one row of pixel circuits 10, and the first gate driving circuit 21 is configured to transmit a first gate driving signal Scan1 to the first reset module 13 of a corresponding one row of pixel circuits 10;

one second gate driving circuit 22 is connected to data writing modules 11 of one row of pixel circuits 10, and the second gate driving circuit 22 is configured to transmit a second gate driving signal Scan2 to the data writing modules 11 of a corresponding one row of pixel circuits 10;

a single effective pulse width of the first gate driving signal Scan1 is the same as a single effective pulse width of the second gate driving signal Scan2.

In an embodiment, a single effective pulse width of the first gate driving signal is the same as a single effective pulse width of the second gate driving signal, that is, the single effective pulse width of the first gate driving signal is 1 times the single effective pulse width of the second gate driving signal. In this way, a row-by-row reset of the driving module can be achieved, and a data voltage (the first data voltage or the second data voltage) can be written to the control terminal of the driving module 12 row by row, facilitating a row-by-row control. Moreover, k=n, that is, the single effective pulse width of the second gate driving signal Scan2 is equal to one row time, which can fully write a data voltage (the first data voltage or the second data voltage), ensuring an integrity of writing the data voltage (the first data voltage or the second data voltage).

In an embodiment, as shown in FIG. 26 and FIG. 27, the display panel further includes a third gate driving circuit 23, the third gate driving circuit 23 is connected to light-emitting control modules 15 of two rows of pixel circuits 10, and provides a light-emitting control signal for the light-emitting control modules 15. In this way, the number of third gate driving circuits 23 can be reduced, saving a space. In some other embodiments, one third gate driving circuit 23 may also be correspondingly connected to one row of pixel circuits 10.

In an embodiment, as shown in FIG. 26 and FIG. 27, the pixel circuits 10 may be located in a display area AA of the display panel, and the first gate circuit 21, the second gate circuit 22 and the third gate circuit 23 may be in a non-display area NA of the display panel. FIG. 26 and FIG. 27 show the non-display area NA as relatively large to illustrate the first gate circuit 21, the second gate circuit 22 and the third gate circuit 23, but the size of the non-display area NA is not limited, nor is a proportional relationship between the size of the display area AA and the size of the non-display area NA limited.

Due to space limitations, the pixel circuits 10 in FIG. 26 and FIG. 27 only show the first reset module 13, the data writing module 11 and the light-emitting control module 15, and do not show other modules and connection relationships between modules. The structure of the pixel circuit 10 can refer to FIG. 1 or FIG. 7. The possible structures that the pixel circuit 10 may have are described below in combination with devices that various modules in FIG. 7 may include.

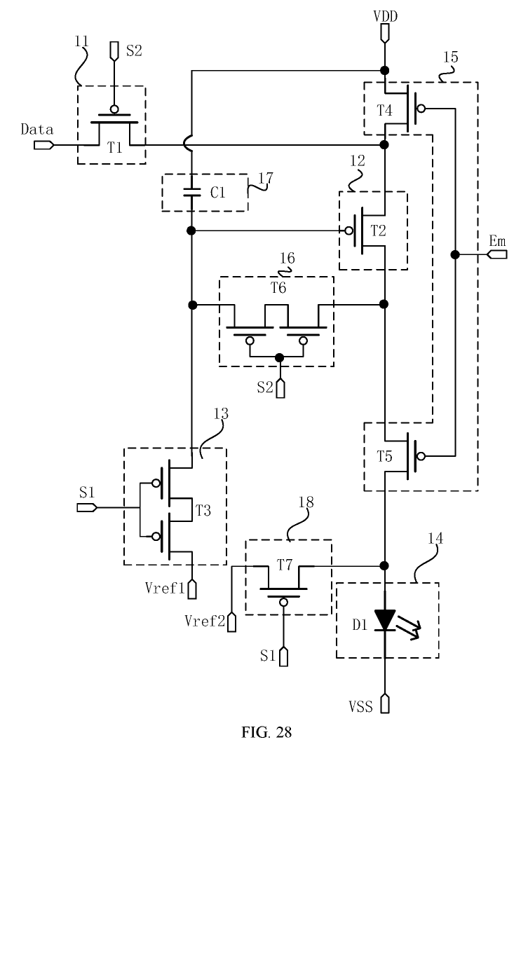

FIG. 28 is a structural schematic diagram of another pixel circuit provided by an embodiment of the present application. As shown in FIG. 28, the data writing module 11 includes a data writing transistor T1, a control electrode of the data writing transistor T1 is connected to the second gate driving line S2, a first electrode of the data writing transistor T1 is connected to the data line Data, and a second electrode of the data writing transistor T1 is connected to a first terminal of the driving module 12;

the driving module 12 includes a driving transistor T2;

the first reset module 13 includes a first reset transistor T3, a control electrode of the first reset transistor T3 is connected to the first gate driving line S1, a first electrode of the first reset transistor T3 is connected to the first reset voltage Vref1, and a second electrode of the first reset transistor T3 is connected to a control electrode of the driving transistor T2; the first reset transistor T3 may be a dual-gate transistor;

the light-emitting module 14 includes a light-emitting diode D1;

the light-emitting control module 15 includes a first light-emitting control transistor T4 and a second light-emitting control transistor T5, the first light-emitting control transistor T4 is connected between the first power source VDD and a first electrode of the driving transistor T2, and the second light-emitting control transistor T5 is connected between a second electrode of the driving transistor T2 and a first electrode of the light-emitting diode D1; control electrodes of the first light-emitting control transistor T4 and the second light-emitting control transistor T5 are connected to the third gate driving line Em; a second electrode of the light-emitting diode D1 is connected to the second power source VSS;

the threshold compensation module 16 includes a threshold compensation transistor T6, the threshold compensation transistor T6 is connected between the first electrode of the driving transistor T2 and a control electrode of the driving transistor T2, and a control electrode of the threshold compensation transistor T6 is connected to the second gate driving line S2; the threshold compensation transistor T6 may be a dual-gate transistor;

the storage module 17 includes a storage capacitor C1, a first electrode of the storage capacitor C1 is connected to the first power source VDD, and a second electrode of the storage capacitor C1 is connected to the control electrode of the driving transistor T2;

the second reset module 18 includes a second reset transistor T7, a control electrode of the second reset transistor T7 is connected to the first gate driving line S1, a first electrode of the second reset transistor T7 is connected to the second reset voltage Vref2, and a second electrode of the second reset transistor T7 is connected to the first electrode of the light-emitting diode D1.

In an embodiment, in the first reset phase, the first gate driving signal provided by the first gate driving line S1 is at an effective level at least once, and the first reset transistor T3 can be controlled to be turned on at least once, and the second reset transistor T7 can be controlled to be turned on at least once, and the first reset transistor T3 resets the control electrode of the driving transistor T2 at least once, and the second reset transistor T7 can reset the first electrode of the light-emitting diode D1 at least once. In the second reset phase, the first gate driving signal provided by the first gate driving line S1 is at an effective level at least once, and the first reset transistor T3 can be controlled to be turned on at least once, and the second reset transistor T7 can be controlled to be turned on at least once, and the first reset transistor T3 resets the control electrode of the driving transistor T2 at least once, and the second reset transistor T7 can reset the first electrode of the light-emitting diode D1 at least once. Thereby, the control electrode of the driving transistor T2 is reset at least twice, which can increase the duration and the number of times of applying a reverse voltage stress to the driving transistor T2. Even the driving transistor T2 with a large characteristic shift can well recover characteristics, and each driving transistor T2 can better recover characteristics, and driving currents generated by different driving transistors T2 under the same gray level tend to be consistent, making light-emitting brightnesses of different light-emitting diodes D1 tend to be consistent, which can improve a display uniformity of the display panel, avoid an afterimage, and improve the display effect of the display panel.

In the first data writing phase, the second gate driving signal provided by the second gate driving line S2 is at an effective level at least once, which can control the data writing transistor T1 and the threshold compensation transistor T6 to be turned on at least once, and the data writing transistor T1 transmits a data voltage (the first data voltage or the second data voltage) on the data line Data to the control electrode of the driving transistor T2 through the driving transistor T2 and the threshold compensation transistor T6 at least once.

In the light-emitting phase, the third gate driving signal provided by the third gate driving line Em is at an effective level, the first light-emitting control transistor T4 and the second light-emitting control transistor T5 are turned on, and the driving transistor T2 generates a driving current, and the light-emitting diode D1 emits light in response to the driving transistor T2.

FIG. 28 shows a case where all transistors are P-type transistors. In some other embodiments, all transistors of the pixel circuit may be N-type transistors, or some may be N-type transistors and another part may be P-type transistors.

Multiple forms of processes shown above can be used to reorder, add or delete steps. In an embodiment, multiple steps described in the present application may be performed in parallel, sequentially, or in different orders, as long as the desired results of the embodiments of the present application can be achieved.

What is claimed is:

1. A driving method for driving a pixel circuit, wherein the pixel circuit comprises a data writing module, a driving module and a first reset module; the data writing module is connected to the driving module, and the first reset module is connected to a control terminal of the driving module; within one display frame, the method comprising:
in a first reset phase, controlling the first reset module to perform a reset on the control terminal of the driving module at least once;
in a second reset phase, controlling the first reset module to perform a reset on the control terminal of the driving module at least once; and
in a first data writing phase, controlling the data writing module to write a first data voltage to the control terminal of the driving module at least once.

2. The method according to claim 1, wherein the method further comprises: between the first reset phase and the second reset phase, performing a second data writing phase,
in the second data writing phase, controlling the data writing module to write a second data voltage to the control terminal of the driving module at least once; or, in the second data writing phase, controlling the data writing module to write a second data voltage to the control terminal of the driving module at least twice;
wherein the pixel circuit further comprises a light-emitting module, and the driving module is connected to the light-emitting module; the method further comprising:
in a light-emitting phase, controlling the driving module to generate a driving current, to cause the light-emitting module to emit light in response to the driving current.

3. The method according to claim 2, wherein the pixel circuit further comprises a storage module, a first terminal of the storage module is connected to a Direct Current signal, and a second terminal of the storage module is connected to the control terminal of the driving module; between the first reset phase and the second data writing phase, the method further comprising:
in a reset maintaining phase, controlling the first reset module and the data writing module to turn off, to cause the storage module to maintain a potential of the control terminal of the driving module; or, in a part of a period of the reset maintaining phase, controlling the first reset module to perform a reset on the control terminal of the driving module at least once, and in another part of a period of the reset maintaining phase, controlling the first reset module and the data writing module to turn off; wherein the another part of the period of the reset maintaining phase is a period from an end of a last reset of the control terminal of the driving module by the first reset module in the reset maintaining phase to a start of the second data writing phase;
or,
the first data writing phase is located before the first reset phase; in the first data writing phase, controlling the data writing module to write a second data voltage to the control terminal of the driving module at least once; in the second data writing phase, controlling the data writing module to write a first data voltage to the control terminal of the driving module at least once; wherein the second reset phase is located before the first data writing phase.

4. The method according to claim 3, wherein before the reset maintaining phase, the method further comprises:
determining a duration of the reset maintaining phase according to a test parameter value of a display panel where the pixel circuit is located; wherein the test parameter value at least comprises an afterimage value of the display panel.

5. The method according to claim 3, wherein between the second reset phase and the first data writing phase, the method further comprises:
in a transition phase, controlling the data writing module and the first reset module to turn off;
wherein a duration of the reset maintaining phase is greater than a duration of the transition phase, or, a duration of the another part of the period of the reset maintaining phase is greater than a duration of the transition phase.

6. The method according to claim 3, wherein between the first reset phase and the reset maintaining phase, the method further comprises performing at least one of the first reset phase;
or, between the reset maintaining phase and the second data writing phase, the method further comprises performing at least one of the first reset phase and at least one of the reset maintaining phase;
wherein the pixel circuit further comprises a second reset module, and the second reset module is connected to the light-emitting module; the method further comprising:
in the first reset phase, controlling the second reset module to perform a reset on the light-emitting module at least once; and
in the second reset phase, controlling the second reset module to perform a reset on the light-emitting module at least once.

7. The method according to claim 1, wherein a single effective pulse width of a control signal of the first reset module is the same in each instance;
a single effective pulse width of a control signal of the first reset module is n times a single effective pulse width of a control signal of the data writing module;
wherein the n is an integer greater than or equal to 1; or, the n is 1 or 2.

8. A driving method for driving a pixel circuit, wherein the pixel circuit comprises a data writing module, a driving module and a first reset module; the data writing module is connected to the driving module, and the first reset module is connected to a control terminal of the driving module; within one display frame, the method comprising:
in a first reset phase, controlling the first reset module to perform a reset on the control terminal of the driving module at least once;
in a second data writing phase, controlling the data writing module to write a second data voltage to the control terminal of the driving module at least once; and
in a first data writing phase, controlling the data writing module to write a first data voltage to the control terminal of the driving module at least once.

9. The method according to claim 8, wherein the pixel circuit further comprises a storage module, a first terminal of the storage module is connected to a direct current signal, and a second terminal of the storage module is connected to the control terminal of the driving module; between the first reset phase and the second data writing phase; the method further comprising:
in a reset maintaining phase, controlling the first reset module and the data writing module to turn off, to cause the storage module to maintain a potential of the control terminal of the driving module;
or, in a part of a period of the reset maintaining phase, controlling the first reset module to perform a reset on the control terminal of the driving module at least once, and in another part of a period of the reset maintaining phase, controlling the first reset module and the data writing module to turn off; wherein the another part of the period of the reset maintaining phase is a period from an end of a last reset of the control terminal of the driving module by the first reset module in the reset maintaining phase to a start of the second data writing phase.

10. The method according to claim 9, wherein between the second data writing phase and the first data writing phase, the method further comprises:
in a second reset phase, controlling the first reset module to perform a reset on the control terminal of the driving module at least once;
or, in the second data writing phase, controlling the data writing module to write a second data voltage to the control terminal of the driving module at least twice;
or, the first data writing phase is located before the first reset phase; in the first data writing phase, controlling the data writing module to write a second data voltage to the control terminal of the driving module at least once; in the second data writing phase, controlling the data writing module to write a first data voltage to the control terminal of the driving module at least once; wherein the second reset phase is located before the first data writing phase;
or, the pixel circuit further comprises a light-emitting module, and the driving module is connected to the light-emitting module; the method further comprising:
in a light-emitting phase, controlling the driving module to generate a driving current, to cause the light-emitting module to emit light in response to the driving current;
or, the pixel circuit further comprises a second reset module, and the second reset module is connected to the light-emitting module; the method further comprising:
in the first reset phase, controlling the second reset module to perform a reset on the light-emitting module at least once; and
in the second reset phase, controlling the second reset module to perform a reset on the light-emitting module at least once.

11. The method according to claim 10, wherein between the second reset phase and the first data writing phase, the method further comprises:
in a transition phase, controlling the data writing module and the first reset module to turn off;
wherein a duration of the reset maintaining phase is greater than a duration of the transition phase; or, a duration of the another part of the period of the reset maintaining phase is greater than a duration of the transition phase.

12. The method according to claim 9, wherein before the reset maintaining phase, the method further comprises:
determining a duration of the reset maintaining phase according to a test parameter value of a display panel where the pixel circuit is located; wherein the test parameter value at least comprises an afterimage value of the display panel.

13. The method according to claim 9, wherein between the first reset phase and the reset maintaining phase, the method further comprises performing at least one of the first reset phase;
or, between the reset maintaining phase and the second data writing phase, the method further comprises performing at least one of the first reset phase and at least one of the reset maintaining phase.

14. The method according to claim 10, wherein a single effective pulse width of a control signal of the first reset module is the same in each instance;
a single effective pulse width of a control signal of the first reset module is n times a single effective pulse width of a control signal of the data writing module;
wherein the n is an integer greater than or equal to 1; or, the n is 1 or 2.

15. A driving method for driving a pixel circuit, wherein the pixel circuit comprises a data writing module, a driving module, a first reset module and a storage module; the data writing module is connected to the driving module, and the first reset module is connected to a control terminal of the driving module; a first terminal of the storage module is connected to a direct current signal, and a second terminal of the storage module is connected to the control terminal of the driving module; within one display frame, the method comprising:
in a first reset phase, controlling the first reset module to perform a reset on the control terminal of the driving module at least once;
in a reset maintaining phase, controlling the first reset module and the data writing module to turn off, to cause the storage module to maintain a potential of the control terminal of the driving module; or, in a part of a period of the reset maintaining phase, controlling the first reset module to perform a reset on the control terminal of the driving module at least once, and in another part of a period of the reset maintaining phase, controlling the first reset module and the data writing module to turn off; and
in a first data writing phase, controlling the data writing module to write a first data voltage to the control terminal of the driving module at least once;
wherein the another part of the period of the reset maintaining phase is a period from an end of a last reset of the control terminal of the driving module by the first reset module in the reset maintaining phase, to a start of the first data writing phase.

16. The method according to claim 15, wherein between the reset maintaining phase and the first data writing phase, the method further comprises:
in a second data writing phase, controlling the data writing module to write a second data voltage to the control terminal of the driving module at least once; wherein the another part of the period of the reset maintaining phase is a period from an end of a last reset of the control terminal of the driving module by the first reset module in the reset maintaining phase, to a start of the second data writing phase; and
in a second reset phase, controlling the first reset module to perform a reset on the control terminal of the driving module at least once;
or, the first data writing phase is located before the first reset phase; in the first data writing phase, controlling the data writing module to write a second data voltage to the control terminal of the driving module at least once; in the second data writing phase, controlling the data writing module to write a first data voltage to the control terminal of the driving module at least once; wherein the second reset phase is located before the first data writing phase; or, in the second data writing phase, controlling the data writing module to write a second data voltage to the control terminal of the driving module at least twice;
or, the pixel circuit further comprises a light-emitting module, and the driving module is connected to the light-emitting module; the method further comprising:
in a light-emitting phase, controlling the driving module to generate a driving current, to cause the light-emitting module to emit light in response to the driving current.

17. The method according to claim 16, wherein between the first reset phase and the reset maintaining phase, the method further comprises performing at least one of the first reset phase;
or, between the reset maintaining phase and the second data writing phase, the method further comprises performing at least one of the first reset phase and at least one of the reset maintaining phase;
wherein the pixel circuit further comprises a second reset module, and the second reset module is connected to the light-emitting module; the method further comprising:
in the first reset phase, controlling the second reset module to perform a reset on the light-emitting module at least once; and
in the second reset phase, controlling the second reset module to perform a reset on the light-emitting module at least once.

18. The method according to claim 16, wherein a single effective pulse width of a control signal of the first reset module is the same in each instance;
a single effective pulse width of a control signal of the first reset module is n times a single effective pulse width of a control signal of the data writing module;
wherein the n is an integer greater than or equal to 1; or, the n is 1 or 2.
